(19) United States
(12) Patent Application Publication
(10) Pub. No.: US 2026/0127388 A1
(43) Pub. Date: May 7, 2026

(54) DOMAIN EXPERTISE SWITCHER

(71) Applicant: Rockwell Automation Technologies, Inc., Mayfield Heights, OH (US)

(72) Inventors: Mario Noble, WillowBrook, IL (US); Kelly Ceballos, Lone Tree, CO (US); Lucas G. Thompson, Cleveland, OH (US); Sylwia Koloczek, Katowice (PL)

(21) Appl. No.: 19/350,705

(22) Filed: Oct. 6, 2025

Related U.S. Application Data
(60) Provisional application No. 63/716,429, filed on Nov. 5, 2024.

(51) Int. Cl. G06F 40/40; G06F 3/0482; G06F 3/0484; G06N 5/022

(52) U.S. Cl. CPC G06F 40/40; G06N 5/022; G06F 3/0482; G06F 3/0484

(57) ABSTRACT

An industrial chatbot system and associated chatbot interface support various user experience features designed to improve the chatbot's utility within an industrial context. These features include the ability to invite selected users or teams to participate in an ongoing chatbot thread or conversation, the ability to switch between knowledge domains during a chatbot session, the ability to save prompts for selective resubmission to the system, the ability to organize and share multiple chatbot threads among different teams or team members, constraining submission of prompts in a collaborative multiuser context so that prompts are submitted and processed in an organized manner, and the ability to define prompt-based dashboards that can be stored and deployed on demand or in response to defined conditions.

### CROSS-REFERENCE TO RELATED APPLICATIONS

This application claims priority to U.S. Provisional Patent Application Ser. No. 63/716,429, filed on Nov. 5, 2024, and entitled “GENERATIVE AI INDUSTRIAL USER EXPERIENCE PROMPT WORKFLOWS,” the entirety of which is incorporated herein by reference.

### TECHNICAL FIELD

The subject matter disclosed herein relates generally to industrial automation systems, and, for example, to the use of industrial chatbots BACKGROUND ART The industrial devices and assets that make up the manufacturing systems operating within an industrial facility generate a large amount of diverse operational, status, and maintenance data. Aggregated analysis of this information could yield useful insights into the plant's operations. However, industrial analysis and reporting systems can be difficult to use, particularly from the standpoint of the user interfaces used to engage with these systems.

The above-described deficiencies of current approaches to resolving industrial alarm conditions and performance issues are merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a generative artificial intelligence (AI) component configured to initiate a chatbot thread, to process natural language prompts received as part of the chatbot thread requesting information about industrial operations within an industrial facility, and to generate, based on generative AI analysis of the natural language prompts, responses to the natural language prompts, the responses comprising at least one of natural language information or graphical content, wherein the generative AI analysis is performed using an analytic model, of a set of available analytic models, trained with a set of training data relevant to a knowledge domain that is currently selected for the chatbot thread; a user interface component configured to render a chatbot interface that receives the natural language prompts and renders the natural language prompts and responses of the chatbot thread, wherein generative AI component is further configured to switch the knowledge domain that is currently selected for the chatbot thread from a first knowledge domain to a second knowledge domain in response to receipt, via interaction with the chatbot interface, of a request to switch the chatbot thread to the second knowledge domain.

Also, one or more embodiments provide a method, comprising, in response to initiation of a chatbot thread, rendering, by an industrial chatbot system comprising a processor, a chatbot interface; receiving, by an industrial chatbot system via interaction with the chatbot interface, selection of a first knowledge domain, from a set of available knowledge domains to be used for the chatbot thread; in response to receiving, via interaction with the chatbot interface as part of the chatbot thread, natural language prompts requesting information about industrial operations within an industrial facility, generating, by the industrial chatbot system based on generative artificial intelligence (AI) analysis of the natural language prompts, responses to the natural language prompts, wherein the responses comprising at least one of natural language information or graphical content, and the generating comprises performing the generative AI analysis using a first analytic model, of a set of available analytic models respectively corresponding to the set of available knowledge domains, trained with a first set of training data relevant to the first knowledge domain; and in response to receiving, via interaction with the chatbot interface, a request to switch the chatbot thread from the first knowledge domain to a second knowledge domain of the set of available knowledge domains, switching, by the industrial chatbot system, the chatbot thread to the second knowledge domain, wherein the switching comprises using a second analytic model, of the set of available analytic models, trained with a second set of training data relevant to the first knowledge domain to analyze subsequent natural language prompts received in the chatbot thread.

Also, according to one or more embodiments, a non-transitory computer-readable medium is provided having stored thereon instructions that, in response to execution, cause an industrial chatbot system to perform operations, the operations comprising rendering a chatbot interface in response to initiation of a chatbot thread; receiving, via interaction with the chatbot interface, selection of a first knowledge domain, from a set of available knowledge domains to be used for the chatbot thread; in response to receiving, via interaction with the chatbot interface as part of the chatbot thread, natural language prompts requesting information about industrial operations within an industrial facility, generating, based on generative artificial intelligence (AI) analysis of the natural language prompts, responses to the natural language prompts, wherein the responses comprising at least one of natural language information or graphical content, and the generating comprises performing the generative AI analysis using a first analytic model, of a set of available analytic models respectively corresponding to the set of available knowledge domains, trained with a first set of training data relevant to the first knowledge domain; and in response to receiving, via interaction with the chatbot interface, a request to switch the chatbot thread from the first knowledge domain to a second knowledge domain of the set of available knowledge domains, switching the chatbot thread to the second knowledge domain, wherein the switching comprises using a second analytic model, of the set of available analytic models, trained with a second set of training data relevant to the first knowledge domain to analyze subsequent natural language prompts received in the chatbot thread.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example industrial chatbot system.

FIG. 3 is a diagram illustrating an example architecture of the industrial chatbot system.

FIG. 4 is a diagram illustrating training of custom models used by the industrial chatbot system.

FIG. 5a is a view of an example chatbot interface that supports the ability to invite new participates into an ongoing chat thread.

FIG. 5b is a view of the chatbot interface after an Invite Others option is selected.

FIG. 5c is a view of the chatbot interface in which one of the thread participants is currently in the process typing a new prompt into his or her instance of the chatbot interface.

FIG. 5d is another view of the chatbot interface in which the prompt entry field is rendering a message indicating that the chatbot system is currently processing a new prompt that was recently submitted to the system.

FIG. 6a is a view of the chatbot interface in which the user has invoked an icon-based domain switching window.

FIG. 6b is another example view of the chatbot interface in which switching of the generative AI domain is performed using a text-based domain switching window.

FIG. 6c is another view of the chatbot interface in which the role of the user who is interacting with the chatbot session can be selected

FIG. 6d is another view of the chatbot interface depicting a Settings page that can be used to define a selectable persona for a chatbot session, and to save these settings as a selectable domain.

FIG. 6e is another view of the chatbot interface in which a user has selected a prompt that had been submitted earlier in an ongoing chatbot thread, and has invoked a Role Selection window.

FIG. 7a is a view of the chatbot interface in which the user has invoked a Prompt Action window as an initial step for creating a selectable prompt action.

FIG. 7b is a view of the chatbot interface in which a Quick Action configuration view is rendered.

FIG. 7c is another view of the Quick Action configuration view in which the user has opted to associate the quick action with a graphical icon.

FIG. 7d is another view of the chatbot interface depicting an example Start screen from which the user can initiate a new chatbot thread.

FIG. 7e is another view of the chatbot interface in which an Actions window has been invoked via selection of a Quick Action option.

FIG. 7f is a view of the chatbot interface in which the user has selected and submitted a quick action for which parameters were defined for a production area and a duration of interest.

FIG. 7g is a view of the chatbot interface after the user has provided parameter values for the quick action.

FIG. 7h is a view of the chatbot interface in which defined quick actions are represented by graphical icons.

FIG. 7i is a view of the chatbot interface in which the user has chosen to invoke a selected quick action by entering the alias of the quick action via the prompt entry field.

FIG. 7j is another view of the chatbot interface that organizes available quick actions (or quick prompts) into categories.

FIG. 7k is an Information view of the chatbot interface for configuring a quick action or quick prompt.

FIG. 7l is a Context view of the chatbot interface for configuring a quick action or quick prompt.

FIG. 7m is Shortcuts view of the chatbot interface for configuring a quick action or quick prompt.

FIG. 7n is a Sharing and More view of the chatbot interface for configuring a quick action or quick prompt.

FIG. 8a is a Threads view of the chatbot interface that allows a user to view lists of existing chatbot threads as organized lists, and to share selected threads with other users or teams of users.

FIG. 8b is a view of the chatbot interface in which the user has selected a thread that is to be shared with a team.

FIG. 8c is a view of the chatbot interface in which the user has selected to add a selected thread to a team.

FIG. 8d is a Threads view of the chatbot interface in which the user has selected a By Team viewing.

FIG. 8e is a view of the chatbot interface in which the user has selected a team.

FIG. 8f is a Threads view of the chatbot interface in which the user has selected a General viewing option.

FIG. 9a is a view of the chatbot interface in the user is one of multiple users currently participating in a chatbot thread.

FIG. 9b is a view of the chatbot interface of a participant in which the prompt entry field indicates that another participant is entering a prompt.

FIG. 10a is an Actions view of the chatbot interface, which displays a list of available quick actions.

FIG. 10b is a Dashboard Configuration view of the chatbot interface that is rendered when the user selects an Add to Dashboard option.

FIG. 10c is a Dashboards view of the chatbot interface which displays a list of dashboards that have been previously created.

FIG. 10d is an example dashboard that can be rendered on the chatbot interface based on execution of a selected dashboard definition.

FIG. 10e is an example dashboard arranged in a grid pattern.

FIG. 10f is a view of the example dashboard depicted in which the user has selected the AI-generated graph and invoked an Options menu listing actions that can be performed on the selected item of content.

FIG. 10g is a view of the dashboard in which a Versions window for the selected graph has been invoked.

FIG. 10h is another example prompt-based dashboard that can be rendered on the chatbot interface.

FIG. 11a is an example prompt chain configuration interface that can be used to define prompt chains and conditions for executing these chains.

FIG. 11b is a Prompt Chain view of the chatbot interface that lists defined prompt chains by name.

FIG. 12a is a flowchart of a first part of an example methodology for switching a knowledge domain within a chatbot thread managed by an industrial chatbot system.

FIG. 12b is a flowchart of a second part of the example methodology for switching a knowledge domain within a chatbot thread managed by an industrial chatbot system.

FIG. 13a is a flowchart of a first part of an example methodology for configuring and submitting a quick prompt within an industrial chatbot system.

FIG. 13b is a flowchart of a second part of the example methodology for configuring and submitting a quick prompt within an industrial chatbot system.

FIG. 13c is a flowchart of a third part of the example methodology for configuring and submitting a quick prompt within an industrial chatbot system.

FIG. 14a is a flowchart of a first part of an example methodology for inviting additional participants to an industrial chatbot thread.

FIG. 14b is a flowchart of a second part of the example methodology for inviting additional participants to an industrial chatbot thread.

FIG. 15a is a flowchart of a first part of an example methodology for regulating entry of natural language prompts in a multi-user industrial chatbot thread.

FIG. 15b is a flowchart of a second part of the example methodology for regulating entry of natural language prompts in a multi-user industrial chatbot thread.

FIG. 16 is an example computing environment.

FIG. 17 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

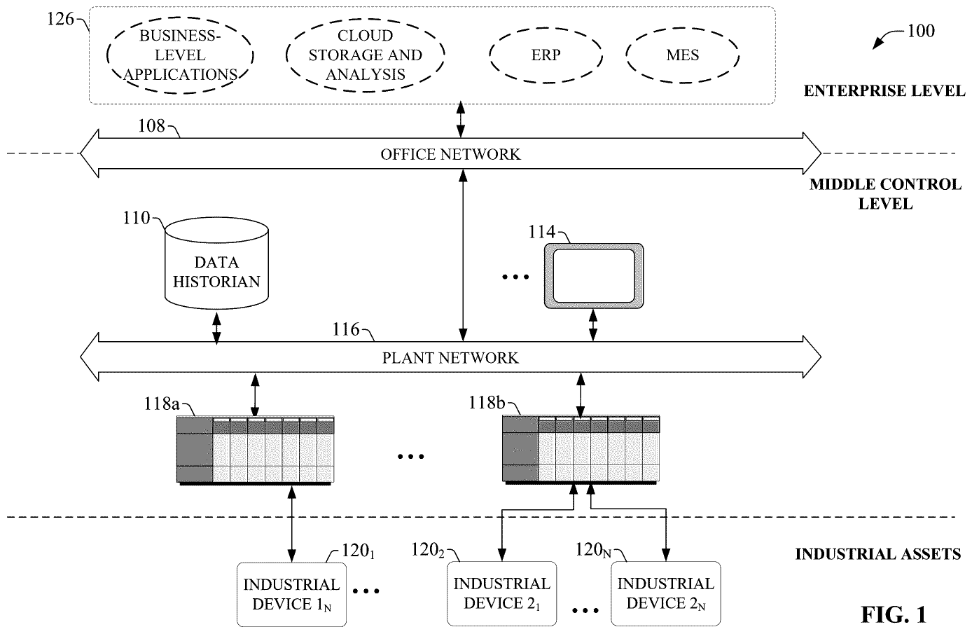

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise substantially any type of control code capable of processing input signals read from the industrial devices 120 and controlling output signals generated by the industrial controllers 118, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), present sensing devices (e.g., inductive or capacitive proximity sensors, photoelectric sensors, ultrasonic sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot controllers, valves, pumps, and the like.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by their associated control programs and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, a data historian 110 that aggregates and stores production information collected from the industrial controllers 118 or other data sources, device documentation stores containing electronic documentation for the various industrial devices making up the controlled industrial systems, inventory tracking systems, work order management systems, repositories for machine or process drawings and documentation, vendor product documentation storage, vendor knowledgebases, internal knowledgebases, work scheduling applications, or other such systems, some or all of which may reside on an office network 108 of the industrial environment.

Higher-level systems 126 may carry out functions that are less directly related to control of the industrial automation systems on the plant floor, and instead are directed to long term planning, high-level supervisory control, analytics, reporting, or other such high-level functions. These systems 126 may reside on the office network 108 at an external location relative to the plant facility, or on a cloud platform with access to the office and/or plant networks. Higher-level systems 126 may include, but are not limited to, cloud storage and analysis systems, big data analysis systems, manufacturing execution systems, data lakes, reporting systems, etc. In some scenarios, applications running at these higher levels of the enterprise may be configured to analyze control system operational data, and the results of this analysis may be fed back to an operator at the control system or directly to a controller 118 or device 120 in the control system.

Maintenance and troubleshooting of a plant's industrial control systems and their associated machines and devices are typically carried out by on-site service engineers or machine operators. While some types of routine machine alarm or fault conditions can be easily addressed, unfamiliar alarm conditions or system performance issues require the service personnel to expend considerable time and effort finding resolutions to the problems. These resolution efforts may involve referencing device or software manuals or contacting a vendor's customer support personnel for assistance in diagnosing and resolving the condition.

Generative artificial intelligence (AI) has the potential to simplify industrial maintenance by quickly providing diagnostic information or other insights about an industrial customer's assets, automation systems, and manufacturing operations. Such industrial generative AI systems could provide accurate answers to specific questions about the customer's assets and operations submitted as natural language prompts. Users can interact with these generative AI-assisted informational systems via chatbot interfaces, through which the users can submit natural language prompts or queries and receive natural language response to those prompts formulated by the system.

One or more embodiments described herein provide an industrial chatbot system that supports various user experience features designed to improve the chatbot's utility within an industrial context.

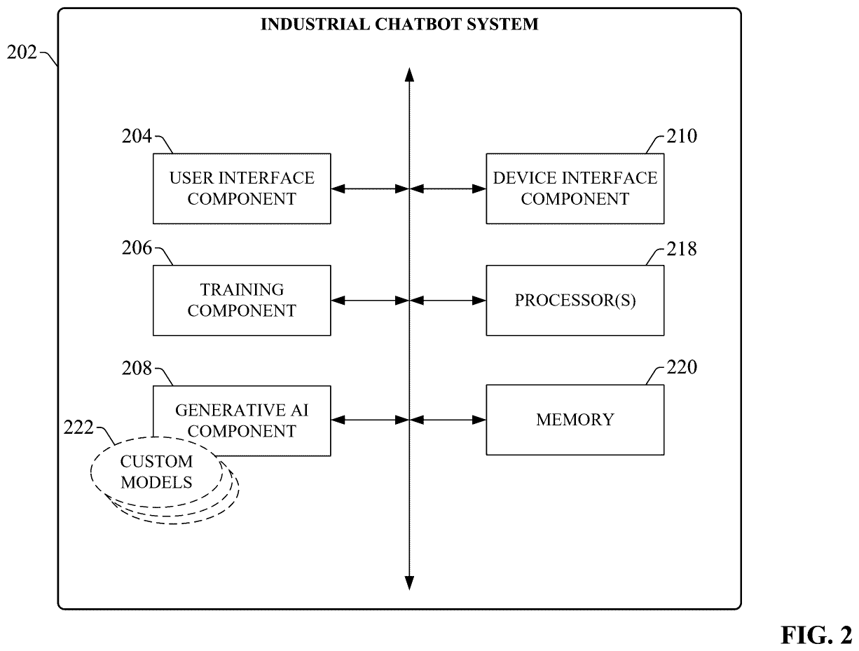

FIG. 2 is a block diagram of an example industrial chatbot system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial chatbot system 202 can include a user interface component 204, a training component 206, a generative AI component 208, a device interface component 210, one or more processors 218, and memory 220. In various embodiments, one or more of the user interface component 204, training component 206, generative AI component 208, device interface component 210, the one or more processors 218, and memory 220 can be electrically and/or communicatively coupled to one another to perform one or more of the functions of the industrial chatbot system 202. In some embodiments, components 204, 206, 208, and 210 can comprise software instructions stored on memory 220 and executed by processor(s) 218. Industrial chatbot system 202 may also interact with other hardware and/or software components not depicted in FIG. 2. For example, processor(s) 218 may interact with one or more external user interface devices, such as a keyboard, a mouse, a display monitor, a touchscreen, or other such interface devices.

User interface component 204 can be configured to receive user input and to render output to the user in any suitable format (e.g., visual, audio, tactile, etc.). In some embodiments, user interface component 204 can be configured to generate and serve chatbot interfaces to a client device (e.g., a laptop computer, tablet computer, smart phone, etc.) that remotely accesses the chatbot system 202 (e.g., via a hardwired or wireless connection). The user interface component 204 can then receive user input data and render output data via the chatbot interface. Input data that can be received via various embodiments of user interface component 204 can include, but is not limited to, natural language prompts requesting information about a customer's industrial assets, requesting content to be generated based on analysis of the customer's real-time or historical asset data, requesting assistance with an automation system alarm or performance conditions, or other such input. Output data rendered by various embodiments of user interface component 204 can include natural language responses to user prompts as part of a chat-based technical support interaction, graphical content generated in response to prompts, insights or recommendations for maintaining or operating a customer's industrial insights, asset training information, or other such outputs.

Training component 206 can be configured to train one or more custom models 222, generative AI models, or knowledgebases with various types of relevant domain-specific training data, including but not limited to industrial product documentation and archived histories of previous problem resolutions. These trained models 222 can be used by the system 202 in connection with processing a user's natural language prompts, as well as formulating and submitting suitable prompts to a generative AI model as needed to assist with generating natural language responses to these user-submitted prompts.

Generative AI component 208 can be configured to generate natural language responses to a user's prompts using generative AI as needed. To this end, the generative AI component 208 can implement prompt engineering functionality using associated custom models 222 trained with domain-specific industrial training data. The generative AI component 208 can generate and submit prompts or meta-prompts to one or more generative AI models and associated neural networks, where these prompts are generated based on natural language requests or queries submitted by the user as well as domain-specific information contained in the custom models 222. Depending on the nature of the user's request or query, the responses returned by the generative AI model in response to the prompts can be used by the generative AI component 208 or the user interface component 204 to render answers to the user's technical support questions, example industrial device configuration settings predicted to solve a configuration or performance problem reported by the user, example maintenance actions predicted to address a reported industrial asset performance issue, or other such technical support recommendations.

Device interface component 210 can be configured to remotely monitor and store real-time operational and status data from industrial devices, assets, and machines across multiple industrial facilities and customers. This collected device data can be used by the generative AI component 208 in connection with formulating responses to users'natural language prompts.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

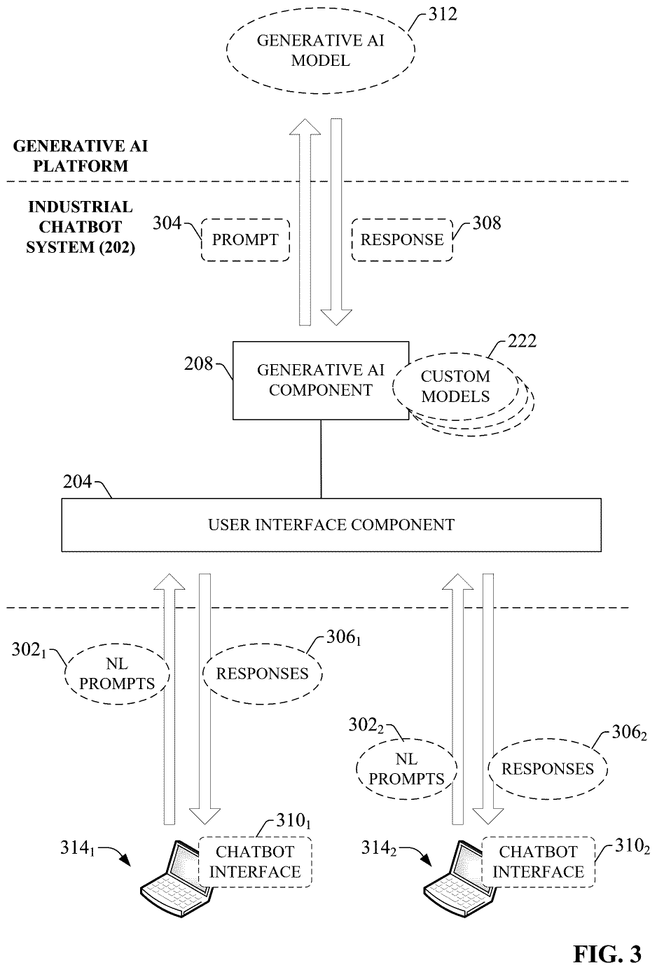

FIG. 3 is a diagram illustrating an example architecture of the industrial chatbot system 202. Some embodiments of the chatbot system 202 can be implemented on a cloud platform, as part of an Internet-of-Things (IoT) system, or on another centralized platform and made accessible to multiple industrial customers having authorized access to use the chatbot system 202. Alternatively, some embodiments of chatbot system 202 may execute at least partially on a local client device while accessing remote services and repositories as needed, or may execute as an entirely on-premise system on a local computing platform.

A client device 314 (e.g., a laptop computer, a tablet computer, a desktop computer, a mobile device, an HMI terminal, a wearable AR/VR appliance, etc.) owned by a user with suitable authentication credentials can access the chatbot system's services. In some embodiments, the chatbot system 202 can be an integrated sub-system of a larger industrial monitoring, analytics, or reporting system that monitors manufacturing operations at multiple customer sites and leverages this data to provide generative AI-assisted responses to user queries regarding these operations. Alternatively, the chatbot system 202 may be implemented as a standalone system for providing chatbot services to industrial customers.

The industrial chatbot system 202 leverages generative AI technologies in connection with providing answers to customers' technical support questions, or information about the customers' industrial assets and operations in response to the customers' natural language prompts. Some embodiments of the chatbot system 202 can also be configured to initiate control actions via control instructions sent to the customers' industrial devices—e.g., modifying control setpoints, changing an operating mode of a machine, etc.—based on the customers' natural language prompts or the system's responses to those prompts. To these ends, system 202 includes a generative AI component 208 that processes a user's natural language prompts 302 and formulates responses 306 (e.g., natural language responses, graphical content, information dashboards, etc.) based on analysis of the prompts 302 together with relevant content of custom models 222 trained with domain-specific industrial training data. Additionally, as part of this analysis, the generative AI component 208 can, as needed, formulate and submit prompts 304 (or meta-prompts) to a generative AI model 312, where these prompts 304 are designed to obtain responses 308 that assist the generative AI component 208 in determining the nature of the information being requested by the user's natural language prompt 302 and formulating a suitable response 306 conveying the requested information (e.g., a recommended technical support action, recommendations for mitigating or addressing the issue, information about a specified industrial asset or manufacturing operation, a graph or chart conveying requested information in a specified format, etc.) In various embodiments, the generative AI model 312 can be any of a diffusion model, a variational autoencoder (VAE), a generative adversarial network (GAN), a language-based generative model such as a large language model (LLM), a generative pre-trained transformer (GPT), a long short-term memory (LSTM) network, or other such models. The generative AI component 208 can implement prompt engineering functionalities using the associated custom models 222, and can interface with the generative AI model 312 and associated neural networks to assist in processing the user's prompts 302 and formulating suitable natural language or graphical responses 306.

Through interaction with chatbot interfaces 310 generated by the system's user interface component 204 and delivered to the client devices 314, users can submit technical support requests or queries in the form of natural language prompts 302. In general, these prompts 302 can specify, using natural language, the nature of the technical problem for which the user requires assistance or a type of information about an industrial asset or manufacturing operation being requested. Example prompts 302 may request information about a specified industrial asset or an observed automation system behavior, recommended countermeasures for observed alarms or performance issues, recommended preventative actions for mitigating future problems, graphs or charts conveying a specified statistic for one or more industrial machines, or other such information. These prompts 302 may include such information as a description or name of an alarm that was generated by a machine, device, or automation system (e.g., “Suggest remedy for high syslog memory alarm,” “Seeing error code: 5000 what do I need to do to fix it?”, etc.); an identity of a device or system for which information is needed together with a description of the type of information required (e.g., “How do I replace the fan on my 755 drive?”, “What is the repair time for my motor drive?”, “What maintenance do I need to do for the MV6000 drive that I have had for about 4 years?”, etc.); performance metrics of a specified production line or machine that the user wishes to see, a graphical format in which the user wishes to see the response (e.g., a line chart, a bar graph, a graphical meter, etc.), or other information describing the type of desired information or support assistance.

Depending on the content of the user's initial prompt 302, the generative AI component 208 may determine that the prompt 302 does not contain sufficient information for providing high-confidence responses 306 (e.g., a response 306 predicted to have a sufficiently high probability of addressing the user's prompt 302), or that additional information from the user about the nature of the information being requested would yield a response 306 having a higher probability of addressing the user's request. In such cases, the generative AI component 208 can render, via the chatbot interface 310, a natural language request for additional information from the user that can be used to refine the user's initial prompt 302 prior to analysis. As part of this process, the generative AI component 208 can prompt the user for specific items of additional information that will refine or enhance the initial prompt 302 in a manner that improves the likelihood that the generative AI component 208 will generate an accurate response 306 that satisfies the user's requirements. In this way, the generative AI component 208 can carry out an iterative natural language dialogue with the user (or with multiple users in a collaborative context), prompting the user to provide sufficient details about the type of information being requested to ensure that the system 202 provides highly reliable and accurate information or technical support guidance.

This iterative approach can also be used to generate and refine response content generated by the chatbot system 202 for a given conversational thread. For example, an initial prompt 302 may yield a response 306 from the system 202 comprising a line graph that conveys requested time-series data, along with a natural language description of the graph and its content. The user, or multiple users in collaboration, can submit additional prompts 302 to the chatbot thread designed to refine the graph (e.g., by changing the type of information being displayed, changing a color scheme of the graph, changing the axes of the graph, adding or removing data points, etc.) until the graph is presenting the desired information in a preferred format.

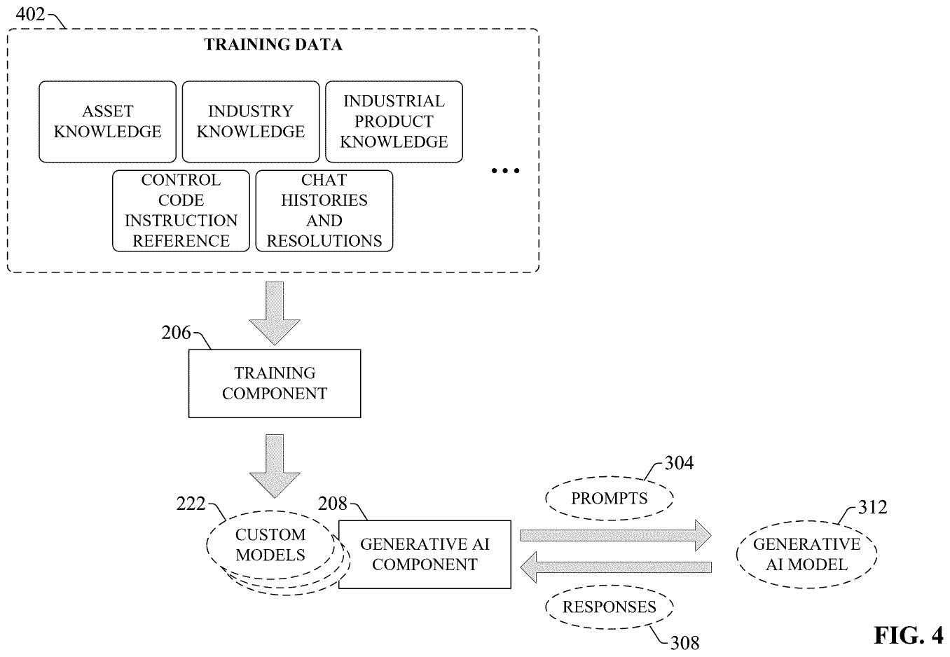

FIG. 4 is a diagram illustrating training of the custom models 222 used by the generative AI component 208. In some embodiments, the generative AI model 312 can reside and execute externally from the industrial chatbot system 202, and the generative AI component 208 can include suitable connectivity tools and protocols, application programming interfaces (APIs), or other such services that allow the generative AI component 208 to exchange prompts 304 and responses 308 with the generative AI model 312. The system's training component 214 can train the custom models 222 using sets of training data 402 representing a range of domain-specific industrial knowledge. Example training data 402 that can be used to train the custom models 222 includes, but is not limited to, libraries of product manuals for various types of industrial devices, assets, machines, or software platforms (including vendor-specific device manuals); help files; vendor knowledgebases; training materials; information defining industrial standards (e.g., global or vertical-specific safety standards, food and drug standards, design standards such as the ISA-88 standard, etc.); technical specifics or design standards for various types of industrial control applications (e.g., batch control processes, die casting, valve control, agitator control, etc.); knowledge of specific industrial verticals; knowledge of industrial best practices; histories of chat threads with the chatbot system 202; and other such training data. Training data 402 can also include proprietary customer-specific data provided by the user (e.g., via retrieval-augmented generation, or RAG), or data provided by other chatbot agents. Although FIG. 4 depicts the use of trained custom models 222, the training data 402 can alternatively be stored in a knowledgebase for access by the generative AI component 208 in some embodiments.

Archived chat histories, which can be stored by the system 202 and used to train the custom models 222 (or otherwise made accessible to the generative AI component 208), can comprise the content of chat threads or sessions between the chatbot system 202 and various users across multiple different customer entities. Each chat history can include the natural language prompts 302 submitted by the user as part of a chat thread, as well as the support guidance, information, or graphical content generated by the generative AI component 208 as responses 306 to these prompts 302. In some embodiments, each chat history can also record feedback that was provided by the user indicating a degree to which the system's responses 306 addressed the concern specified by the initial prompt 302. This information can be leveraged by the generative AI component 208 in connection with formulating responses 306 to subsequent prompts 302 determined to be similar to the archived prompt 302.

As part of the analysis and processing of a user's natural language prompt 302, the generative AI component 208 can, as needed, formulate and submit prompts 304 to the generative AI model 312 designed to obtain responses 308 that assist the generative AI component 208 in ascertaining details of the technical issue or request to which the user's prompt 302 is directed and generating suitable natural language or graphical responses 306 for addressing the issue or satisfying the request. The generative AI component 208 can generate these prompts 304 based on content of the user's natural language prompt 302 as well as the industry knowledge and reference data encoded in the trained custom models 222. The generative AI component 208 can reference custom models 222 as needed in connection with processing a user's natural language prompts 302 and prompting the generative AI model 312 for responses 308 that assist the generative AI component 208 in formulating natural language responses 306 to the user's prompt 302. Prompts 304 generated and submitted by the generative AI component 208 can include any information that assists the generative AI model 312 in converging on a useful response 308 that can be used to formulate responses 306 (either natural language responses or graphical content) addressing the user's prompt 302, including but not limited to an identity, name, or description of the industrial asset or device that is the subject of the user's prompt 302 (e.g., a name or type of machine or industrial device), an indication of the type of industrial process or application being carried out by the industrial asset of interest (e.g., a specific type of batch processing, a specific automotive manufacturing function, a sheet metal stamping application, etc.), any selected subsets of the training data 402 determined to be relevant to the user's prompt 302, or other such data.

Although FIGS. 3 and 4 depict an architecture in which the training data 402 is used to train custom models 222 that are separate from the generative AI model 312 itself, and that are leveraged, together with responses 308 prompted from the generative AI model 312, to formulate natural language responses 306 to users' natural language prompts 302, in some architectures the generative AI model 312 itself can be trained directly using the training data 402.

Returning to FIG. 3, in addition to prompts 302 comprising natural language queries or requests for specific types of information relating to the customer's manufacturing process and associated industrial machines and devices, users can also submit other types of input to via the chatbot interface 310, including but not limited to documentation (e.g., product manuals, standards documentation), engineering drawings or other types of engineering documents, device or process configuration information (e.g., recipe data, control loop setpoints or tuning parameters, device settings, etc.), spreadsheets, or other such input. The chatbot system 202 can process these documents together with any other user inputs (e.g., natural language prompts 302 requesting a specific type of content to be generated based on the uploaded documents) to yield natural language responses 306 or other types of content satisfying the user's requests.

In addition to natural language responses 306, the chatbot system 202 can also generate other types of content in accordance with the user's prompts 302 and other submitted input, including but not limited to control programming (e.g., ladder logic programming, structured text, etc.), HMI application files, engineering documents (e.g., electrical or mechanical drawings, standards documentation, technology transfer documents, etc.), device configuration files, purchase orders, performance reports for the customer's industrial assets or machines, or other such content.

Various user experience features of the system's chatbot interface 314 according to one or more embodiments are now described. Some embodiments of the chatbot system 202 can permit multiple users associated with a common industrial customer or enterprise to participate in a common generative AI chatbot thread. To facilitate multi-user chatbot sessions, the system 202 allows a user to invite other participants to a current chatbot thread via interaction with his or her instance of the chatbot interface 310, allowing multiple users to collaborate synchronously or asynchronously to shape the content of system's responses 306. Once two or more participants have joined the thread, those participants can interact with each other as well as with the chatbot to co-create generative AI-assisted content.

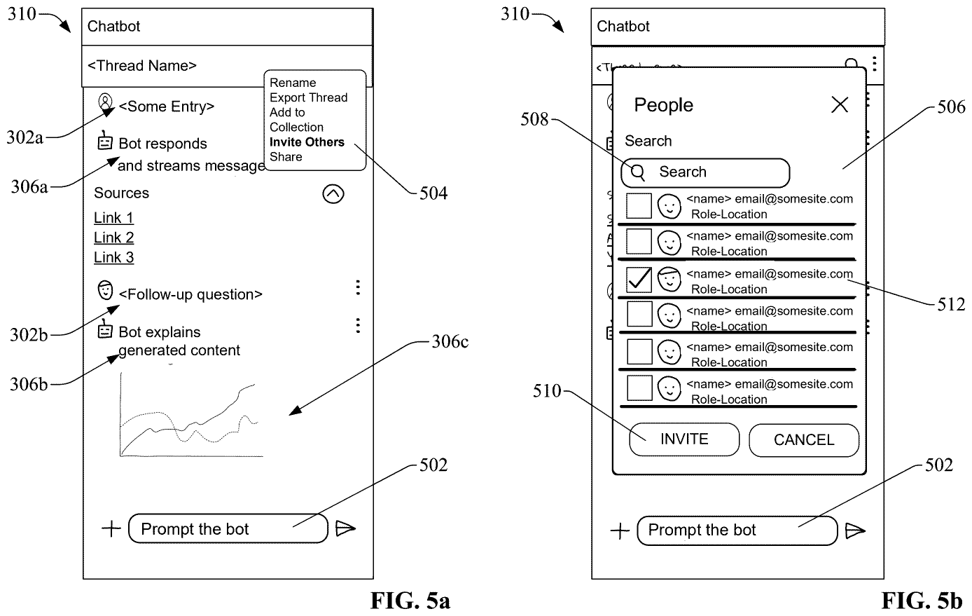

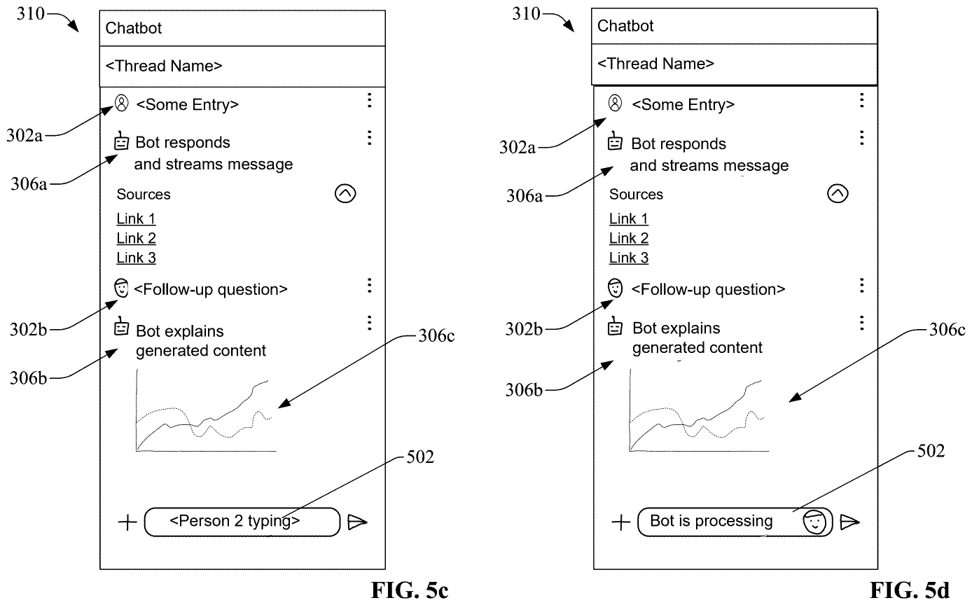

FIG. 5a is a view of an example chatbot interface 310 that supports the ability to invite new participants into an ongoing chat thread. In this example, the chatbot interface 310 comprises a dialog window having a prompt entry field 502 in which the user can enter natural language prompts 302 for processing by the chatbot system 202 as described above. Previous prompts 302 within the current chat thread are displayed in sequence above the entry field 502, with the system's response 306 to each previous prompt 302 displayed below its corresponding prompt 302. As shown in the example view in FIG. 5a, responses 306 can include alphanumeric natural language responses, such as responses 306a and 306b, as well as graphical content such as response 306c (e.g., line graphs, bar charts, pie charts, HMI content, graphical meters etc.), which may be generated based in part on historical or real-time data collected from the customer's industrial assets by the device interface component 210. As noted above, responses 306 may also include such content as control programming, device configuration files, HMI applications, engineering documents, or other such content generated with the assistance of generative AI.

To invite one or more other users to participate in the chatbot thread, the user can invoke a drop-down command window 504 or another type of control having a selectable option to invite other participates (e.g., “Invite Others”). FIG. 5b is a view of the chatbot interface 310 after the Invite Others option is selected from the command window 504. When the Invite Others option is selected, the chatbot interface 310 renders a People Selection window 506 that lists eligible participants who may be invited to participate in the current chatbot session. The list of eligible participants can comprise registered employees of a common industrial enterprise, and may be further filtered such that only employees who are members of a defined engineering or maintenance team are made available for selection. Each entry 512 corresponding to an eligible participant can display the name of the participant as well as other information about the participant, such as the participant's email address, role within the organization, location, current availability status, or other such information. The People Selection window 506 can also include a search field 508 that allows the user to search for specific people to be invited.

To invite one or more people to the current chatbot thread, the user can select the names of the employees listed on the window 506 who are to be invited, then select an Invite button 510 rendered on the window 506. In response to these selections, the user interface component 204 sends invitation notifications to the selected people via the chatbot platform (e.g., on the selected participants' instances of the chatbot interface 310) or via an external platform on which the selected participants may view the notification (e.g., the participants' email address, a text notification, a social media notification, a remote meeting platform, etc.). The selected participants may then opt to enter the chatbot thread via their own instances of the chatbot interface 310. The user interface component 204 will render the chatbot thread content on the chatbot interfaces 310 of all invited participants who enter the chatbot thread, including past prompts 302 and responses 306 that were generated prior to the invited participants' entry into the thread.

To assist in coordinating submission of user prompts 302 when multiple people are participating in the same chatbot thread, the prompt entry field 502 can also render dynamic status information indicating when a participant is in the process of entering a prompt 302. FIG. 5c is a view of the chatbot interface 310 in which one of the thread participants is currently in the process typing a new prompt 302 into his or her instance of the chatbot interface 310. While a participant is typing a prompt 302 into their instance of the prompt entry field 502, the prompt entry fields 502 of the chatbot interfaces 310 of the other participants render a message indicating that the participant is in the process of typing a prompt 302 (e.g., “<Participant Name> is typing”). In some embodiments, if a user is currently typing in a prompt 302, the chatbot interfaces 310 of the other users may prevent those other users from entering prompts 302 via their own instances of the interface 310, ensuring that prompts 302 are submitted to the system 202 in a regulated sequential manner, and preventing the system 202 from being required to process multiple prompts 302 simultaneously.

The prompt entry field 502 can also render other types of status information on the respective participants' instances of the chatbot interface 310. For example, FIG. 5d is another view of the chatbot interface 310 in which the prompt entry field 502 is rendering a message indicating that the chatbot system 202 is currently processing a new prompt 302 that was recently submitted to the system 202.

In a multi-user collaborative chatbot thread, participants can submit prompts 302 to the thread either synchronously or asynchronously. In a synchronous multi-user chatbot thread, multiple participants are viewing the thread via their respective instances of the chatbot interface 310 at the same time, with the participants submitting prompts 302 in turn and with the system 202 rendering the responses 306 to these prompts 302 substantially simultaneously on all participant's chatbot interfaces 310. In an asynchronous multi-user chatbot thread, users may enter and leave the thread at different times. The chatbot system 202 maintains a record of the thread—including the history of prompts 302 and corresponding responses 306—even if the participants have left the thread. When a user re-enters the thread at a later time, the history of prompts 302 and responses 306 is rendered on the user's chatbot interface 310 and the user can resume the thread by submitting further prompts 302.

When interacting with some chatbot systems, the chatbot's responses are sometimes limited to a specific domain of knowledge or perspective, which in turn limits the chatbot's ability to provide relevant content, may increase costs due to higher charges associated with generative AI processing, and may result in a decrease in performance relative to responses that are more constrained.

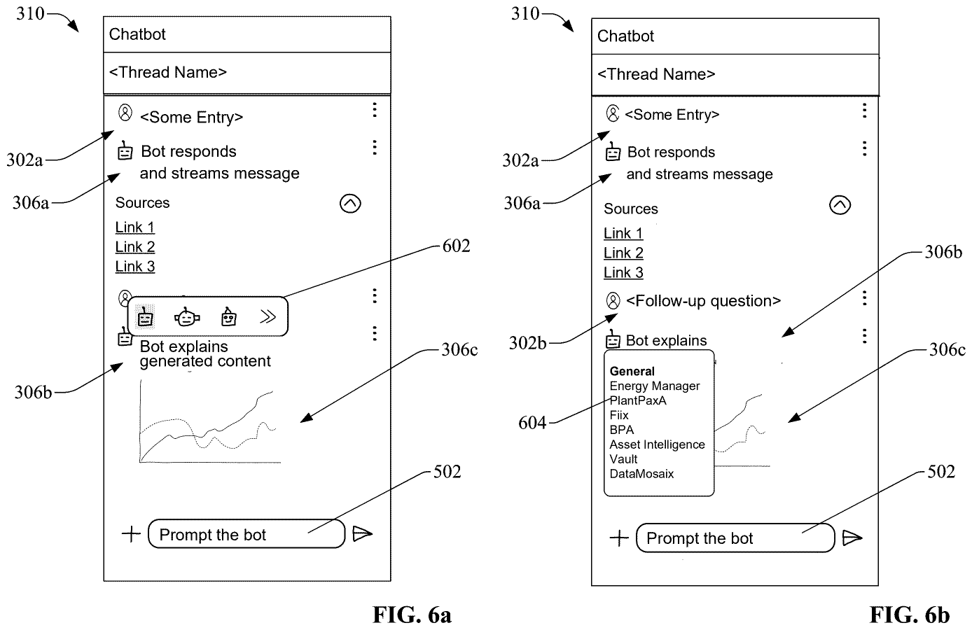

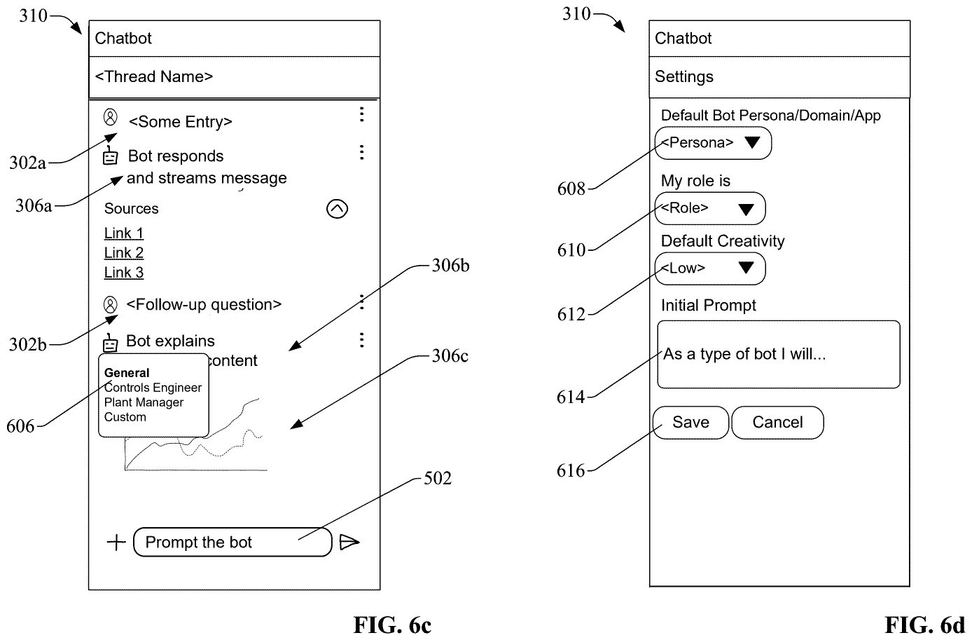

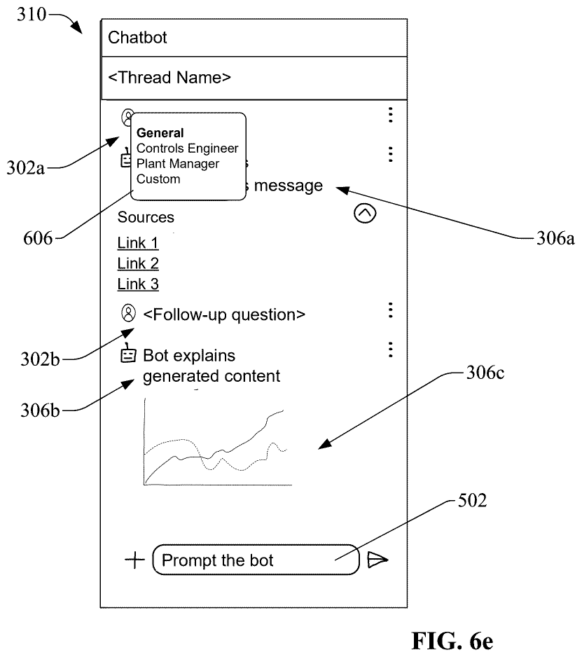

To address this issue, one or more embodiments of the industrial chatbot system 202 described herein can support switching of a chatbot session between different domains (e.g., different persona, role, or knowledge domains). These different domains may correspond to different custom models 222 that are trained with respective different sets of domain-specific training data 402; different generative AI models 312 that are fine-tuned to align with different specialized persona, role, or knowledge domains; or other such domains. FIGS. 6a-6e are various views of the chatbot interface 310 depicting example controls that can be used to switch chatbot domains for a present chatbot session. FIG. 6a is a view of the chatbot interface 310 in which the user has invoked an icon-based domain switching window 602. This window 602 comprises multiple selectable icons arranged horizontally and representing respective different chatbot domains. Selection of an icon from the window 602 causes the current chatbot session to switch to a different domain represented by the selected icon, such that subsequent prompts 302 submitted via the prompt entry field 502 will be directed to a generative AI model 312 and/or custom models 222 corresponding to the selected domain.

FIG. 6b is another example view of the chatbot interface 310 in which switching of the generative AI domain is performed using a text-based Domain Switching window 604, which is invoked via interaction with the interface 310. This window 604 lists available domains as a vertically arranged list of selectable domain names. Selection of a domain name on the window 604 causes the domain for the current chatbot session to be switched to the selected domain. Example domains or personas that can be selected via the window 604 can include, but are not limited to, an energy management domain, a plant efficiency domain, a plant security domain, a controls engineering domain, a financial domain, a domain specific to a particular industrial software platform, a work order domain, a data optimization domain, a batch process analytics domain, a domain specific to an industrial vertical (e.g., automotive, food and drug, textiles, mining, etc.), or other such domains.

FIG. 6c is another view of the chatbot interface 310 in which the role of the user who is interacting with the chatbot session can be selected or changed. Selecting the user's role can instruct the chatbot system 202 to customize the chatbot's responses 306 to the selected role. Example roles can include, for example, controls engineer, plant manager, line operator, maintenance, or other such roles. In this example, the role can be switched by invoking a Role Selection window 606 that lists the available roles as a list of selectable role names. Selection of a role from the window 606 causes the role for the current chatbot session to be switched to the selected role.

FIG. 6d is another view of the chatbot interface 310 depicting a Settings page that can be used to define a selectable persona for a chatbot session, and to save these settings as a selectable domain. In this example, the chatbot domain, persona, or application can be selected using a drop-down menu 608. Another drop-down menu 610 can be used to set the role of the user who will be interacting with the chatbot session (e.g., controls engineer, plant manager, etc.). Another drop-down menu 612 can be used to set the creativity level of the chatbot for the present chat session (e.g., low, medium, or high), which can tailor the wording of the chatbot's responses 306 to different types of audiences. An Initial Prompt field 614 allows the user to write an initial prompt that will be presented by the chatbot interface 310 when a user switches to the chatbot persona presently being defined. This initial prompt may, for example, identify the type and purpose of the selected chatbot to the user. Selecting a Save button 616 causes the settings that were selected using drop-down menus 608, 610, and 612, as well as the initial prompt defined in field 614, to be saved as a selectable chatbot persona. This customized chatbot persona can subsequently be selected (e.g., using selection controls similar to those shown in FIGS. 6a-6c) during an ongoing chatbot thread, causing subsequent prompts 302 submitted in the thread to be processed using the defined chatbot persona.

In some embodiments, users may also select a prompt 302 that was previously submitted to, and processed by, a first domain or under a first user role, and resubmit this selected prompt 302 to a selected second domain or under a different role for reprocessing. FIG. 6e is another view of the chatbot interface 310 in which a user has selected a prompt 302a that was submitted earlier in an ongoing chatbot thread, and has invoked a Role Selection window 606. Selecting a different role using this window 606 causes the selected prompt 302a to be reprocessed by the system 202 using the selected user role, which may cause the system 202 to replace the previous response 306a to this prompt 302 with a modified response 306a that better aligns with the selected role. This new response may also cause subsequent responses (e.g., responses 306b and 306c) to be updated in accordance with the new response 306a or role, if appropriate. A similar approach can be used to change the domain used to process a previous prompt 302a as well.

Although the examples described above considered scenarios in which the user manually selects a knowledge domain to be used for the current chatbot thread, some embodiments of the system 202 can automatically switch from a currently selected knowledge domain to a different domain inferred to be more suited to the current thread based on the context of the user's prompts 302, or may render a suggestion to switch to a different knowledge domain in response to determining that another domain would be better suited to the context of the user's thread.

The example controls illustrated in FIGS. 6a-6e allow users to explicitly switch between domains, personas, or roles for a current chatbot thread or session within the chatbot interface 310. This can improve the chatbot system's ability to present relevant constrained information in response to user prompts, even if the relevant domain is required to be changed during the chatbot session.

In some scenarios, obtaining useful content from a generative AI chatbot can be an involved process that requires the user to iteratively submit additional contextual information to guide the chatbot to a useful output. For common complex chatbot prompts, this can lead to redundant submission of similar prompts and contextual information for respective different but similar informational needs. For example, in a given scenario in which a user requires information relating to an occurrence that happens frequently within the plant, the user must either re-enter a similar set of prompts 302 and contextual information (which may be specific to the current occurrence) or copy and re-submit a previous prompt 302 and associated contextual information while making any necessary modifications to adapt the re-used prompt 302 for the specifics of the present situation.

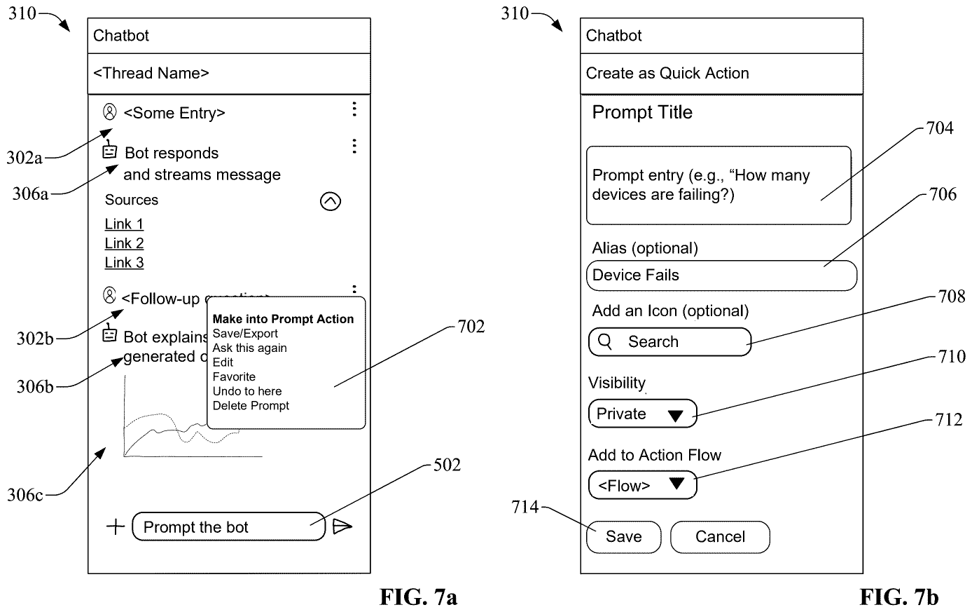

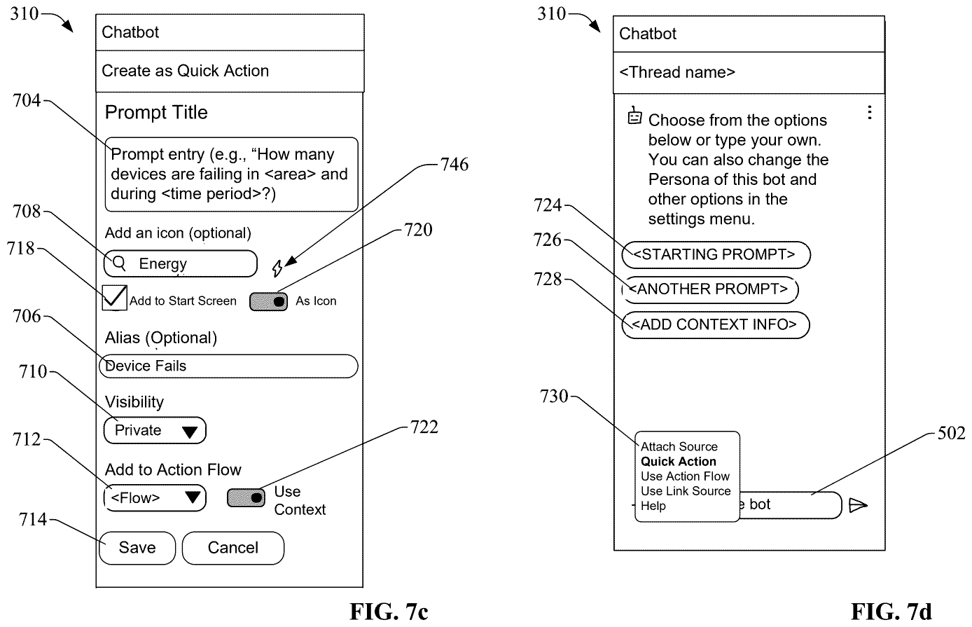

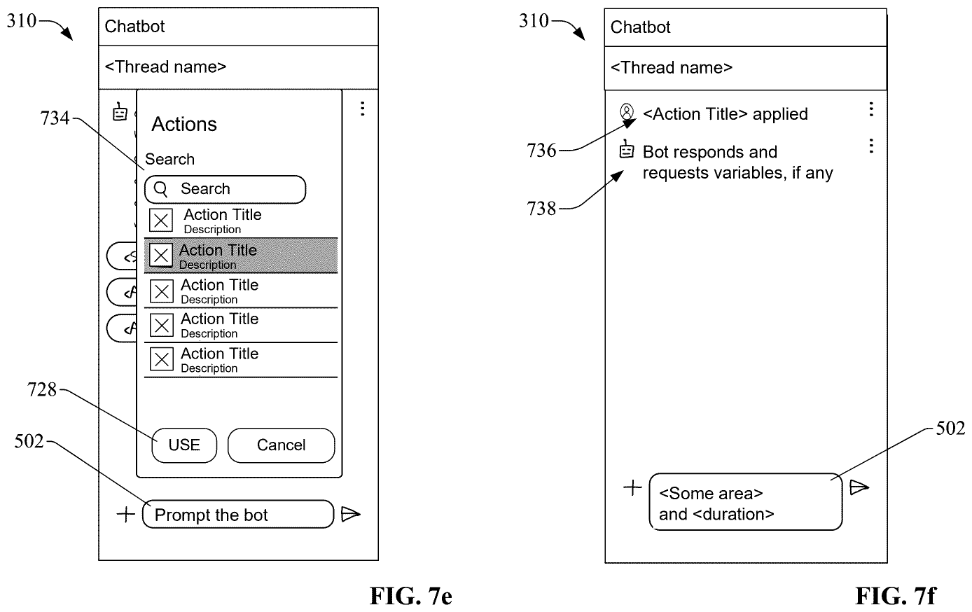

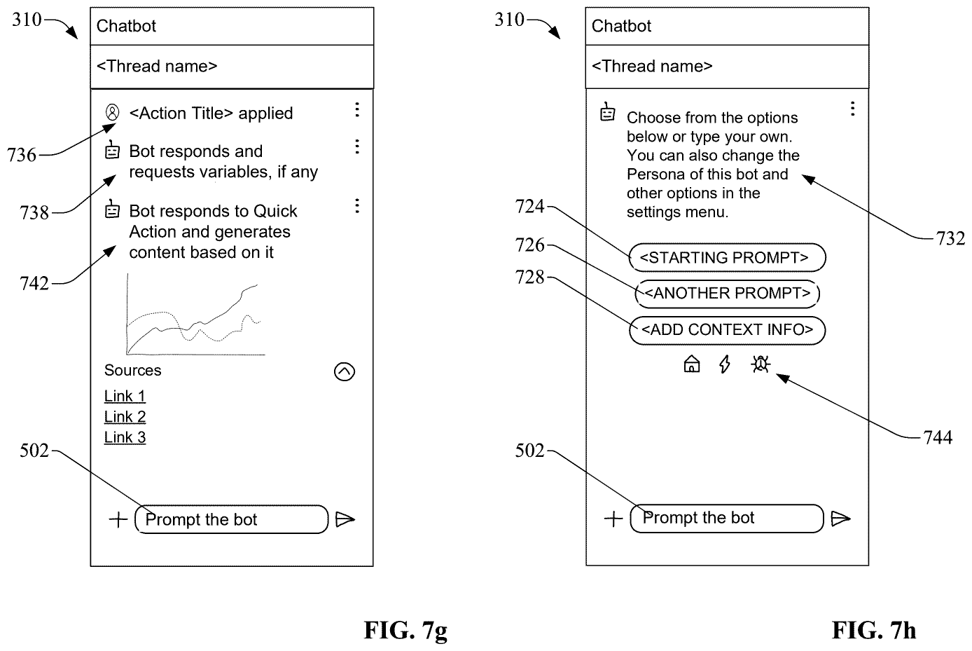

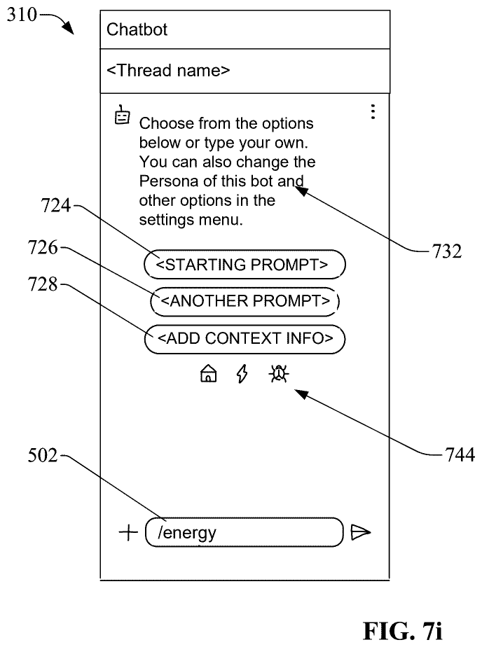

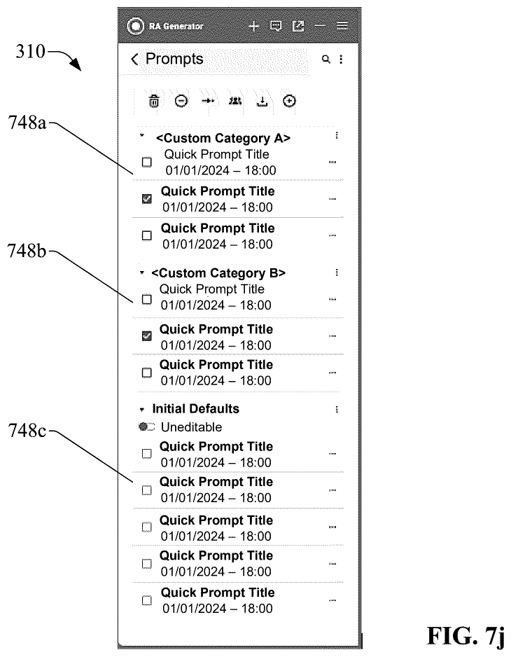

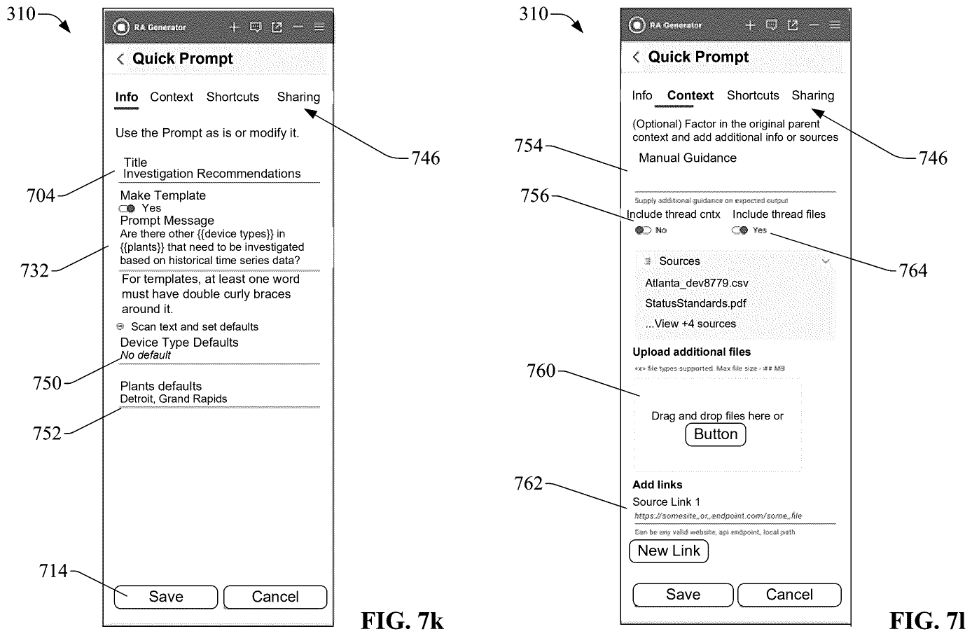

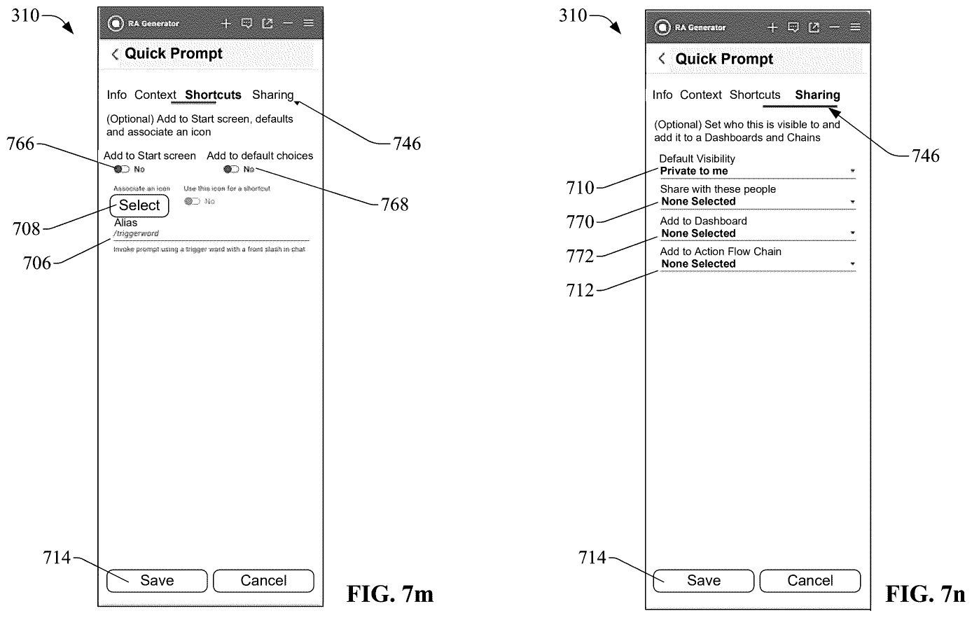

To address this, some embodiments of the chatbot system 202 can also support the ability to encapsulate complex chatbot prompts into reusable selectable actions. FIG. 7a is a view of the chatbot interface 310 in which the user has invoked a Prompt Action window 702 as an initial step for creating a selectable prompt action. In general, the chatbot system 202 can allow the user to save a prompt 302 as a reusable quick prompt that can be invoked in various ways, such as by using shortcut text and a special character (e.g., “/<action name>”), selecting the action prompt from list, or selecting a graphical icon representing the prompt action. To allow these reusable quick prompts to be customized for variations, the system 202 allows the user to also add parameters to these saved prompts, such that the values of these parameters can be entered by the user when the saved prompt is selected.

In the example depicted in FIG. 7a, the user has initiated the process of creating a quick action (also referred to as a quick prompt) by invoking a Prompt Action window 702 via a suitable interaction with the chatbot interface 310 (e.g., a right-click action or selection of a suitable control). The Prompt Action window 702 lists a number of selectable options, including options to save the submitted prompts 302 as a saved prompt action, edit the current thread, resubmit a selected prompt 302, add a prompt 302 as a favorite, delete a selected prompt 302, or other such actions. The user can opt to create a reusable prompt from scratch, or to save one or more selected prompts 302 of an existing chatbot thread as a quick prompt (e.g., by right-clicking on the selected prompt 302 to invoke the Prompt Action window 702).

Selecting an option to save a prompt 302 as a quick action (also referred to as a quick prompt or prompt action) from the Prompt Action window can invoke a Quick Action configuration view. FIG. 7b is a view of the chatbot interface 310 in which the Quick Action configuration view is rendered. The Quick Action configuration view can include data entry fields for configuring specifics of the quick action, including a Prompt Title field 704 for entering a title for the quick action (e.g., “How many devices are failing?”), an Alias field 706 for entering an alias or name for the quick action, an Icon field 708 for selecting a graphical icon that is to represent the quick action, a Visibility field 710 for setting a view permission for the quick action (e.g., private or public), and an Action Flow field 712 for specifying an action flow to which the quick action will be added.

The prompt title entered in the Prompt Title field 704 can comprise the prompt 302 that will be submitted to the chatbot system 202 when the quick action is selected. If the user had selected to save an existing prompt 302 from a chatbot thread as a quick action, this field 704 may be automatically populated with the text of the selected prompt 302. If the prompt entered in the Prompt Title field 704 contains a word, value, or phrase that may require modification when the quick action is invoked for different scenarios (e.g., a specific production area, an identity of a specific industrial asset or device, a time period or duration of interest, a device type of interest, a plant identifier, a product type, etc.), the user can replace these portions of the prompt in the Prompt Title field 704 with corresponding parameter names delineated by special characters, such as open and closed brackets (e.g., “How many devices are failing in <area> and during <time period>”). In some embodiments, as an alternative to manually delineating variable parameters within the prompt, the system 202 can infer which portions of the prompt have a high likelihood of representing a parameter—e.g., inferring that the name “Area 1” in the prompt represents an area within the plant that the user may wish to manually set to customize the quick action when submitted—and automatically delineate these portions of the prompt as configurable parameters.

FIG. 7c is another view of the Quick Action configuration view in which the user has opted to associate the quick action with a graphical icon. The user can interact with the Icon field 708 to select a predefined icon for the quick action (e.g., an Energy icon, as shown in the illustrated example). When the user selects an icon in field 708, the chatbot interface 310 renders additional controls to further configure the behavior of the icon. For example, checkbox 718 allows the user to specify whether the quick action will be displayed on the chatbot interface's main start screen, and a switch control 720 allows the user to specify whether the quick action will be displayed as the selected graphical icon or, alternatively, as an alphanumeric name (e.g., the alias specified in the Alias field 706). Similarly, if the user selects an action flow in the Action Flow field 712, a switch control 722 is displayed that allows the user to select whether context will be used.

Once the user has set desired values in these fields, the configured quick action can be saved by selecting the Save button 714. The chatbot interface 310 will then render the configured quick action available for selection as part of a chatbot session. FIG. 7d is another view of the chatbot interface 310 depicting an example Start screen from which the user can initiate a new chatbot thread. To initiate a new thread, the user can enter a new prompt 302 in the prompt entry field 502 as described above, choose from among predefined options represented by buttons 724, 726, and 728, or invoke a menu window 730 that includes a selectable Quick Action option. Selecting the Quick Action option from menu window 730 invokes a list of quick actions that were previously defined as described above. FIG. 7e is another view of the chatbot interface 310 in which an Actions window 734 has been invoked via selection of the Quick Action option. Actions window 734 lists the quick actions that have been defined as described above and that are available for selection. The quick actions are listed by their title (as defined via the Prompt Title field 704) or by their alias (as defined using the Alias field 706). Selecting a quick action from this list, then selecting the Use button 728, submits the prompt represented by selected quick action to the chatbot system 202. If parameters (or variables) were defined for the prompt represented by the selected quick action, the chatbot can respond by requesting the parameters. FIG. 7f is a view of the chatbot interface 310 in which the user has selected and submitted a quick action for which parameters were defined for a production area and a duration of interest. The chatbot interface 310 displays the prompt 736 represented by the quick action in the chat window, followed by an initial response 738 requesting values of the parameters required by the prompt (e.g., “For which production area?”, “For which duration?”, etc.). The user can submit the requested parameter value in reply to the response 738 via the prompt entry field 502, or may choose to accept a default value of the parameter. FIG. 7g is a view of the chatbot interface 310 after the user has provided the parameter values. The chatbot system 202 processes the prompt defined by the quick action using the values of the parameters submitted by the user and generates a response 742 to this prompt, which is rendered in the chat thread.

FIG. 7h is a view of the chatbot interface 310 in which defined quick actions are represented by graphical icons 744. If one or more quick actions have been defined as having associated icon representations as described above in connection with FIG. 7c, the chatbot interface 310 will display these icons 744 on the interface's start screen. Selecting one of these icons 744 causes the prompt represented by the corresponding quick action to be submitted as described above.

Quick actions can also be invoked using shortcut text delineated by a special character. FIG. 7i is a view of the chatbot interface 310 in which the user has chosen to invoke a selected quick action by entering the alias of the quick action via the prompt entry field 502. In this example, the quick action is invoked by entering a forward slash, or another special character, followed by the text of the alias of the desired quick action (e.g., “energy”). Entering this shortcut causes the quick action represented by the alias to be invoked and submitted to the system 202. The text of the alias for the quick action can be set via the Alias field 706 of the Quick Action configuration view.

Some embodiments of the chatbot system 202 can also allow quick actions to be organized into custom categories so that users can easily find suitable quick actions for selection and submission. FIG. 7j is another view of the chatbot interface 310 that organizes available quick actions (or quick prompts) into categories. In the illustrated example, a first section 748a lists quick actions that are assigned to a first custom category (Custom Category A) and a second section 748b lists quick actions that are assigned to a second custom category (Category B). Quick actions that are not assigned to a category are listed in a third section 748c (Initial Defaults). In some embodiments, this organized listing of quick actions can replace the Actions window 734 depicted in FIG. 7e for selection of a desired quick action or quick prompt.

FIGS. 7k-7n are views of the chatbot interface 310 depicting alternative Quick Action (or Quick Prompt) configuration views that can be invoked via the Prompt Action window 702 and used to configure a quick action. In these examples, the quick action configuration controls are distributed across four selectable views that can be selected using corresponding tabs of a tabbed menu bar 746 near the top of the interface 310. FIG. 7k depicts an Info view on which the Prompt Title field 704 is rendered. This Info view also contains other configuration controls, such as a Prompt Message field 732 for entering a text of the quick prompt (including any parameters that may be required from the user, such as a device name and plant identifier) and fields for entering default values for any parameters in the prompt message, such Device Type Default field 750, and a Plant Default field 752.

FIG. 7l depicts a Context view containing other quick action configuration controls, such as a Manual Guidance field 754 for entering additional constraints, examples, or directions that should be taken into account by the chatbot when generating a response to the quick action; controls 756, 764 for indicating whether the quick action should include thread context or thread files; a selection field 760 for adding additional files to be submitted to, and considered by, the generative AI component 208 as part of the analysis of the quick prompt; and an Add Links field 762 for adding source links.

FIG. 7m depicts a Shortcuts view on which is rendered the Icon field 708 for selecting a graphical icon that is to represent the quick action and the Alias field 706 for entering the alias that can be used to trigger the quick action. Additionally, the Shortcuts view can include a control 766 for selecting whether to add the quick action to a start screen and a control for selecting whether to add the quick action to a list of default choices. FIG. 7n depicts a Sharing and More view on which the Visibility field 710 and Action Flow field 712 are rendered. Additionally, the Sharing and More view includes a Share field 770 for identifying other users with whom results of the quick prompt can be shared, an Add to Dashboard field 772 for identifying dashboards to which the quick action should be added as a selectable option.

In some embodiments, the system 202 can also allow quick actions to be strung together or added into the chatbot's main screen as a custom interface, rather than relying on starter prompts designed by developers or generated automatically by the chatbot system 202.

By allowing commonly used prompts to be encapsulated as saved quick actions that can be selectively invoked with parameter variations, the system 202 provides a low code method to generate different results using the same saved quick action as a template. This can reduce redundant effort and cost by encapsulating and parameterizing complex prompts for simple re-deployment.

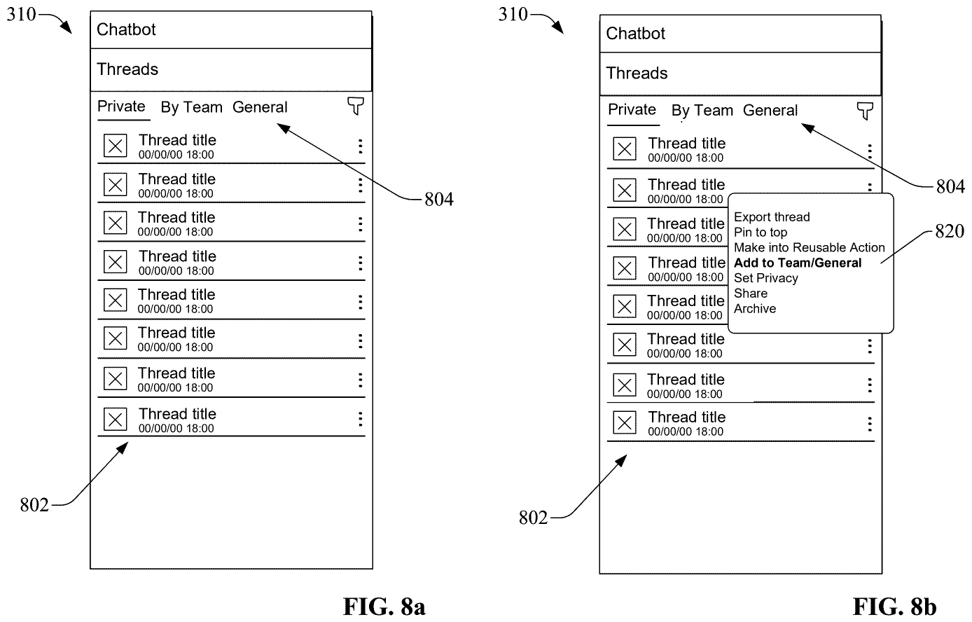

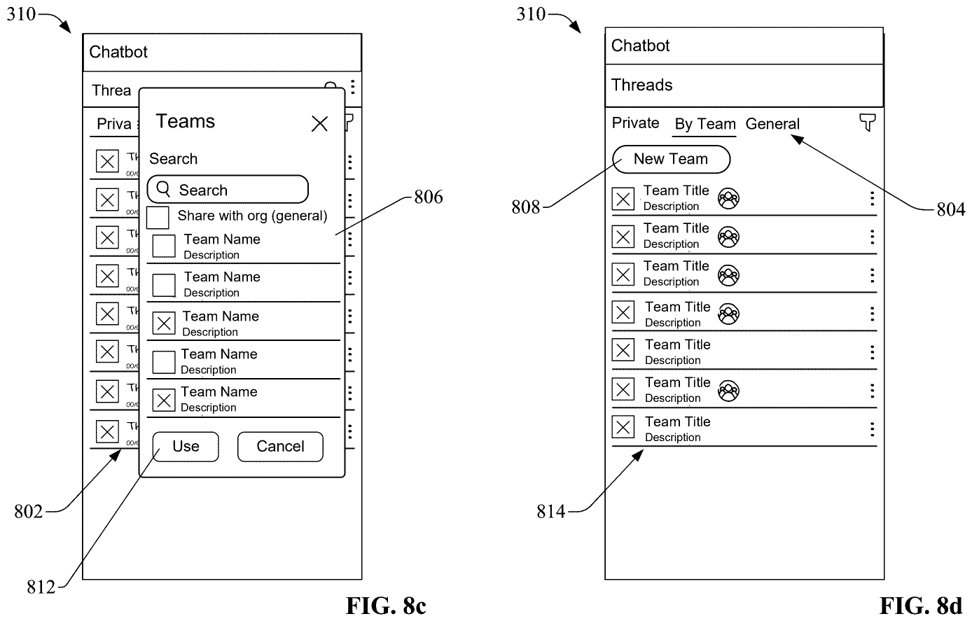

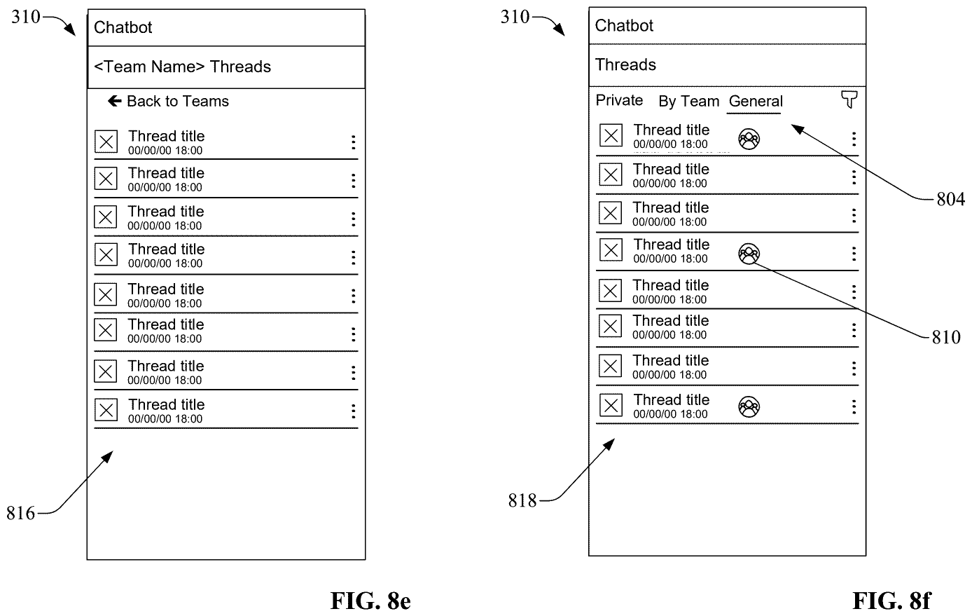

Some embodiments of the chatbot system can also allow users to organize and share multiple chatbot threads with members of a team, with other teams, or with an organization as a whole. FIG. 8a is a Threads view of the chatbot interface 310 that allows a user to view lists of existing chatbot threads as organized lists, and to share selected threads with other users or teams of users. This Threads view includes a tabbed navigation bar 804 comprising selectable tabs corresponding to respective viewing options. In the illustrated example, these options include a Private viewing option that lists the user's private chatbot threads, a By Team viewing option that lists threads that have been assigned to respective teams, and a General viewing option that lists all threads together with team assignment indicators. In the scenario depicted in FIG. 8a, the user has selected the Private viewing option, which causes the chatbot interface 310 to render a list 802 of the user's private chatbot threads. Each entry of the list 802 comprises a name of the chatbot thread, and may also include a description of the thread, a date of the thread, or other such information. The user can invoke a selected thread by selecting on the entry of the list 802 corresponding to the desired thread.

Additionally, if desired, the user can share selected threads with other users or teams of users through interaction with the Threads view. FIG. 8b is a view of the chatbot interface 310 in which the user has selected a thread from the list 802 that is to be shared with a team. To initiate the process of sharing a selected thread, the user can invoke an Options menu 820 via interaction with the entry corresponding to the selected thread (e.g., by right-clicking on the entry). This menu 820 lists various actions that can be performed on the selected thread, such as exporting the thread, pinning the thread to the top of the list 802, designating the thread as a resolvable action, adding the thread to a team or to a general category, setting a privacy of the thread, sharing the thread with a selected user, or archiving the thread (which causes the thread to be removed from the list 802 and stored in an archive).

FIG. 8c is a view of the chatbot interface 310 in which the user has selected the option to add the selected thread to a team. Selecting this option from the Options menu 820 causes the chatbot interface 310 to render a Team Selection window 806 that lists available teams with which the thread can be shared. The teams listed in window 806, and the specific users assigned to each team, can be defined separately, as will be described below. The user can select one or more teams listed on the Teams Selection window 806 with whom the selected thread is to be shared (e.g., by toggling a selection control associated with each desired team). Selecting the Use button 812 causes the chatbot system 202 to share the selected chatbot threads with the selected teams. This can involve changing the visibility and permissions of the selected threads such that the threads can be viewed by, and interacted with, members of the selected teams via their instances of the chatbot interface 310. In some embodiments, rather than offering full access permission to the selected teams, the user can opt to share only a summary of the selected threads with the selected teams. This summary can comprise, for example, the final output or content generated by the system 202 as a result of the conversational thread, while omitting some or all of the prompts 302 used to generate the content.

FIG. 8d is the Threads view of the chatbot interface 310 in which the user has selected the By Team viewing option of the tabbed navigation bar 804. Selecting this viewing option causes the interface 310 to render a list 814 of the teams that have been defined in the system 202. Each entry of the list 814 can comprise the name or title of the team, together with a description of the team. This view also allows the user to create a new team by selecting a New Team button 808, which renders suitable interfaces for configuring a name for the new team and selecting members to be included in the team.

Selecting a team from the list 814 causes the chatbot interface to list the chatbot threads that are currently designated to the selected team. FIG. 8e is a view of the chatbot interface 310 in which the user has selected a team from the list 814, which causes a list 816 of the chatbot threads assigned to that team to be displayed. The user can selectively invoke any of the threads in the list 816 that the user is permitted to view (e.g., threads associated with teams of which the user is a member).

FIG. 8f is the Threads view of the chatbot interface 310 in which the user has selected the General viewing option of the tabbed navigation bar 804. Selecting this viewing option causes the chatbot interface to render a list 818 of public viewable chatbot threads as well as the user's private threads. In some embodiments, the interface 310 can also render graphical icons 810 next to selected threads indicating that those threads are assigned to one or more teams.

By allowing users to organize chat threads into various categories, and to share selected threads with other users or teams, through interactions with the chatbot interface 310, the chatbot system 202 can facilitate easier and better collaboration between team members, reduce redundant work between teams, and increase the quality of the generative AI content generated by the system 202.

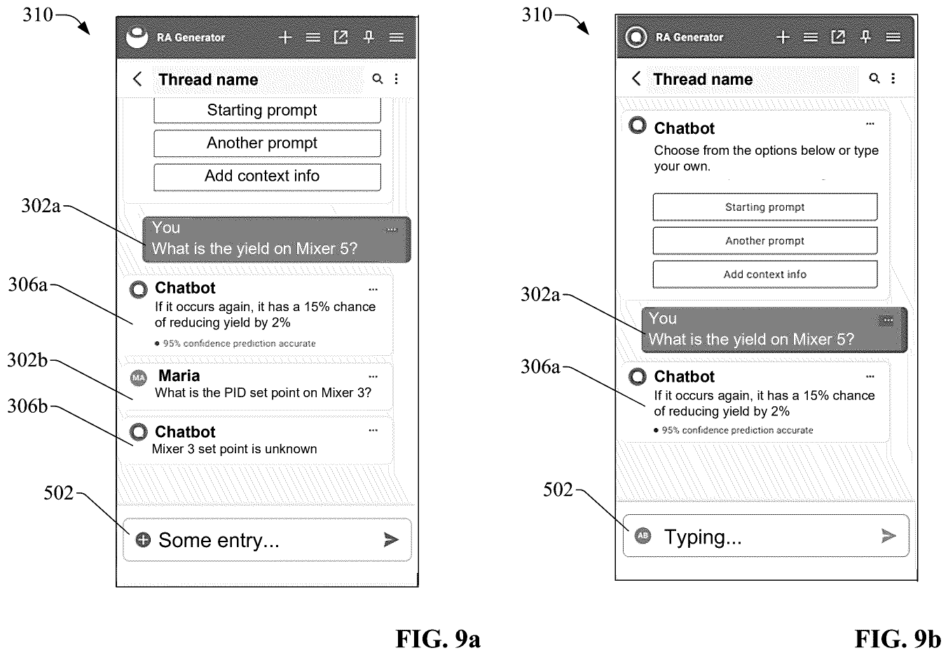

When multiple users are interacting with the same chatbot thread via their respective instances of the chatbot interface 310 (e.g., when members of a common team are currently interacting with the chatbot conversation), the user interface component 204 can render feedback on the users' instances of the chatbot interface 310 to inform when one of the users is currently entering a prompt into the prompt entry field 502. FIG. 9a is a view of the chatbot interface 310 in the user is one of multiple users currently participating in a chatbot thread. When none of the participants are currently in the process of entering a prompt into the prompt entry field 502, the field 502 is either left blank or contains a default text message indicating that a user may begin entering a prompt 302. When the user interface component 204 detects that a participant is in the process of entering a prompt 302 into the prompt entry field 502 via that participant's instance of the chat interface 310, the user interface component 204 renders text in the prompt entry fields 502 of the other participants' instances of the chatbot interface 310 indicating that the user is currently entry a prompt 302. FIG. 9b is a view of the chatbot interface 310 of a participant who is not currently entering a prompt 302 as another participant is entering a prompt 302 via another instance of the chatbot interface 310. In this example, the user interface component 204 renders the message “Typing” in the prompt entry field 502 to convey to the other participants that a prompt 302 is being entered. In some embodiments, while a participant is in the process of typing a prompt 302 into the prompt entry field 502, the user interface component 204 can prevent other participants from entering prompts 302 via their own chatbot interfaces 310, thereby ensuring that the chatbot system 202 will not be required to process multiple simultaneous prompts 302.

Although the foregoing example considers a scenario in which the participants enter prompts 302 as typed input, similar feedback can be provided in scenarios in which users are submitting prompts 302 as spoken input. In such cases, while user interface component 204 detects that one of the participants is speaking a prompt 302 via his or her chatbot interface 310, the user interface component 204 can prevent submission of spoken or typed prompts 302 via other instances of the chatbot interface 310 until the participant has finished submitting the prompt 302. Preventing or discouraging simultaneous or redundant prompting in this manner can reduce prompt processing costs relative to unregulated submission of prompts 302.

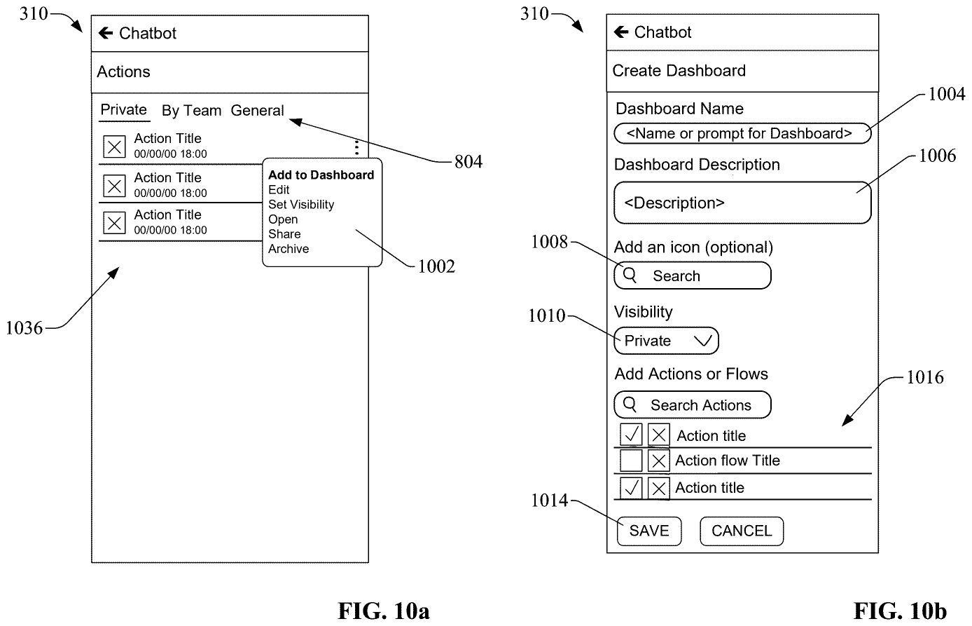

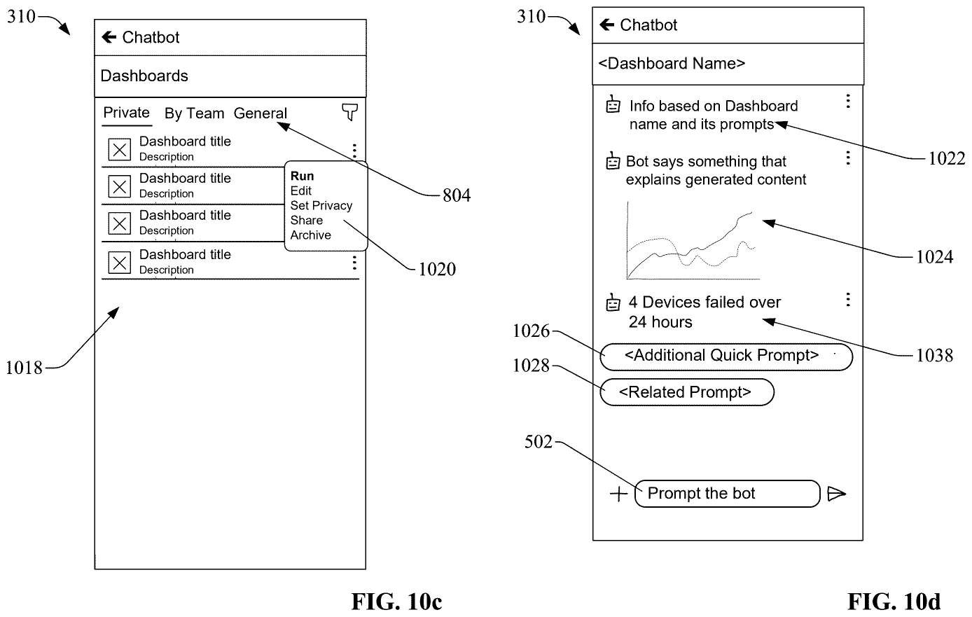

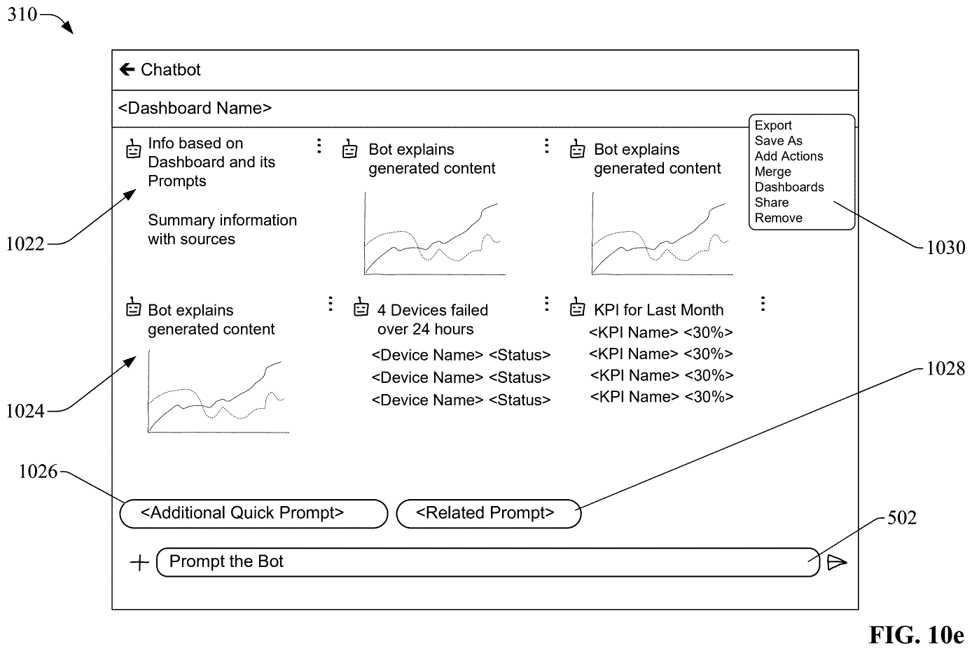

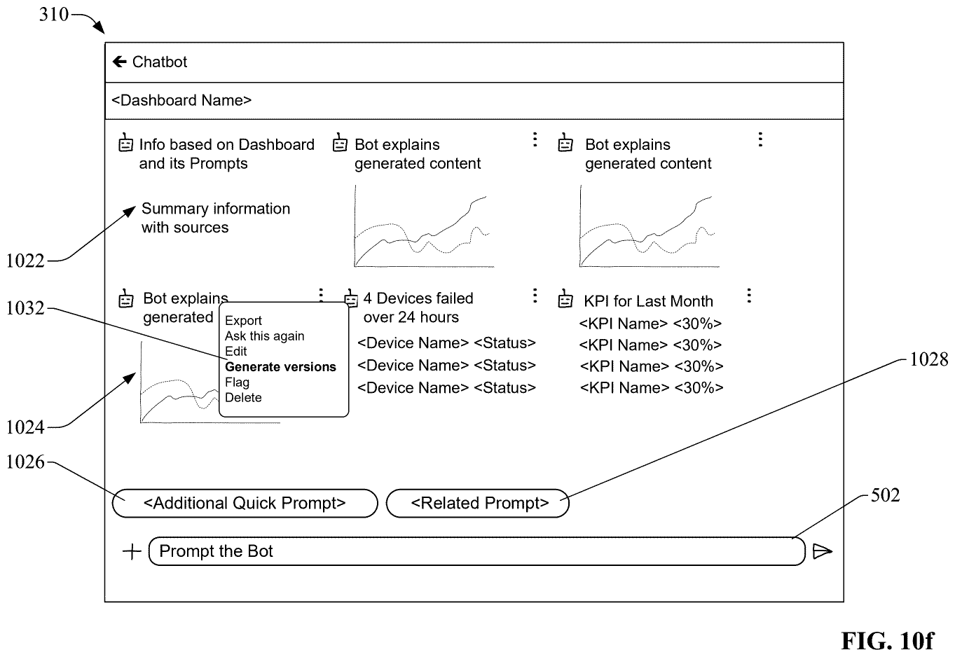

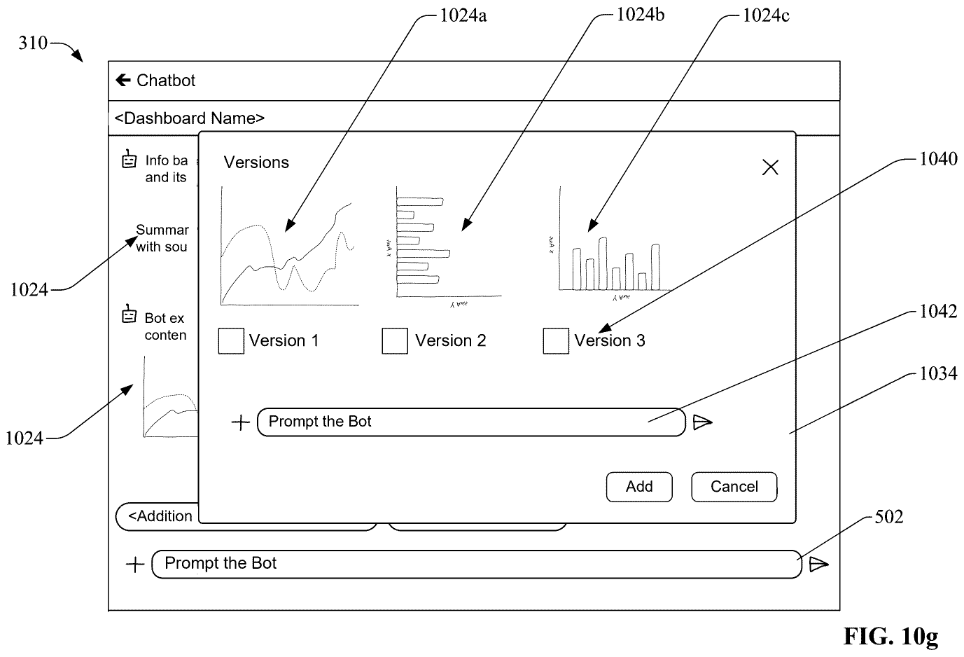

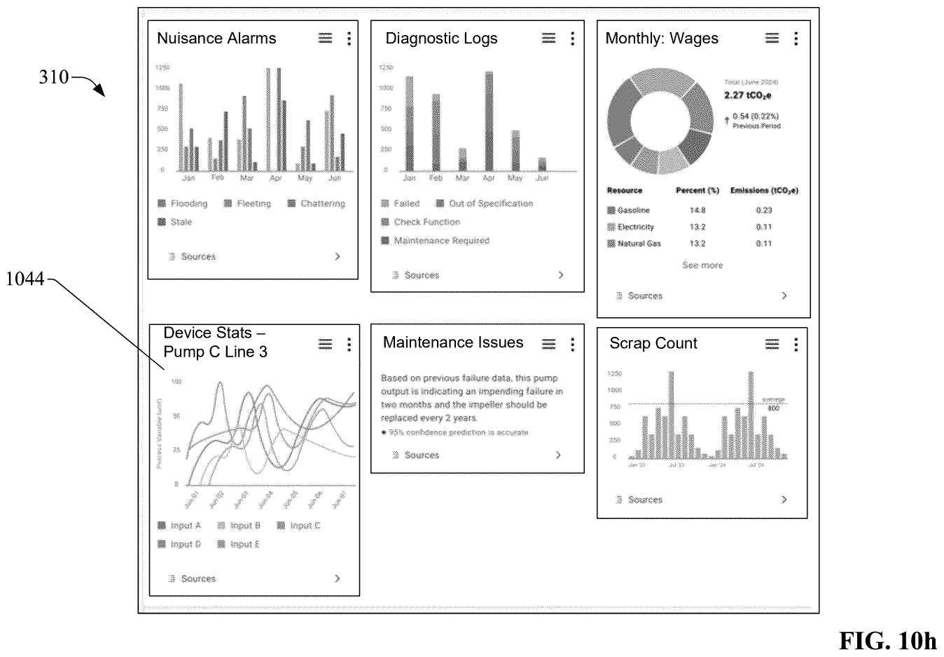

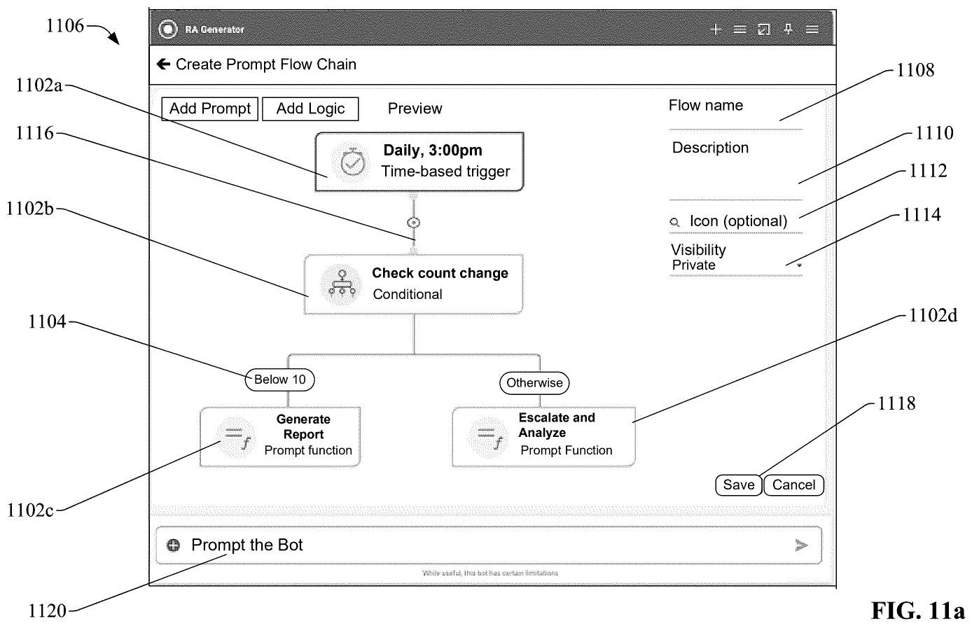

Some embodiments of the chatbot system 202 can also allow users to assemble quick prompts (or quick actions) into groups of prompts that can be selectively submitted, or that can be automatically processed by the chatbot system 202 at specified times, to create ad hoc dashboards, which themselves can be shared and modified as needed. FIG. 10a is an Actions view of the chatbot interface 310, which displays a list 1036 of quick actions (or quick prompts) that have previously been created by the user as described above in connection with FIGS. 7a-7j. To configure one or more of these quick actions to serve as the basis for a prompt-based dashboard, the user can invoke an Options menu 1002 which includes an option to add one or more quick actions to a dashboard. FIG. 10b is a Dashboard Configuration view of the chatbot interface 310 that is rendered when the user selects the Add to Dashboard option from menu 1002. This view allows the user to configure properties of the dashboard. The Dashboard Configuration view includes a Dashboard Name field 1004 for defining a name of the dashboard, a Dashboard description field 1006 for defining a description of the dashboard, an Icon field 1008 that allows the user to specify a graphical icon that is to represent the dashboard, a Visibility field 1010 that allows the user to set the visibility or privacy level of the dashboard (e.g., private, public, accessible only to specified users or teams, etc.), and a list 1016 of available quick actions. To define the prompt-based dashboard, the user can select one or more quick actions from the list 1016 which are to serve as the basis for the new dashboard. When all configuration settings have been defined, selecting a Save button 1014 causes the system 202 to create the new dashboard in accordance with the user's configuration settings.

FIG. 10c is a Dashboards view of the chatbot interface 310 which displays a list of dashboards that have been created as described above in connection with FIGS. 10a and 10b. Similar to the Threads view illustrated in FIGS. 8a-8f, the Dashboards view includes a tabbed navigation bar 804 comprising selectable tabs corresponding to respective viewing options. The navigation bar 804 allows the user to selectively view private dashboards, dashboards that are assigned to respective teams, or a general category of dashboards. Each entry in the list 1018 includes the name and description of the corresponding dashboard, as set using the Dashboard Name field 1004 and Dashboard Description field 1006. In this view, the user can select any of the dashboards in the list 1018 and invoke an Options menu 1020 that lists available actions that can be applied to the selected dashboard. Example actions that can be selected from the menu 1020 include running or executing the dashboard, editing the dashboard, setting a privacy level of the dashboard, sharing the dashboard with other users or teams, or moving the dashboard to an archive and removing the dashboard from the list 1018. Selecting the Run option from menu 1020 causes the system 202 to execute the selected dashboard by processing the quick actions associated with the selected dashboard.

FIG. 10d is an example dashboard that can be rendered on the chatbot interface 310 based on execution of a selected dashboard as described above in connection with FIG. 10c. When a dashboard is selected, the generative AI component 208 processes the quick actions (or quick prompts) associated with the dashboard and generates dashboard content based on this processing. In the example dashboard depicted in FIG. 10d, the chatbot system 202 generates an initial response 1022 comprising information about the selected dashboard (e.g., a function of the dashboard or a description of the type of information presented by the dashboard) as well as a time-series graph 1024 that plots one or more metrics of the customer's plant operations (or another type of generative AI-generated content) together with a description of the graph 1024. The dashboard may also include other information rendered as natural language responses 1038 (e.g., a response to one of the quick actions asking for the number of device failures over a specified time period).

The dashboard can also include a control 1026 that allows the user to further refine the dashboard by selecting an additional quick action (or quick prompt) to be processed by the system 202, which updates the dashboard content based on the result generated in response to this additional quick action. The user can also further refine the dashboard by submitting a new prompt using another control 1028. Also, if desired, the user can modify or customize the dashboard by altering one of the dashboard's underlying quick actions or prompts. These modifications to the dashboard after the dashboard has been generated can either be made temporary (e.g., for the current chatbot thread only, such that subsequent executions of the dashboard will not incorporate the added or modified prompts) or rendered permanent by saving the prompt additions or modifications to the original dashboard definition.

The content of the example dashboard illustrated in FIG. 10d is oriented in a vertically linear manner, similar to the linearized layout a chatbot thread. In some scenarios, the user may instead instruct the chatbot system 202 to render the dashboard in a grid pattern. FIG. 10e is an example dashboard arranged in a grid pattern. In this example, content generated by the system 202 in response to the dashboard's prompts is organized both vertically and horizontally in a grid-like formation.

In some embodiments, the user can invoke an Options menu 1030 via interaction with a dashboard being viewed. This options menu 1030 lists actions that can be selectively performed on the dashboard, including but not limited to exporting the dashboard to another application, saving the dashboard for later viewing, adding actions or prompts to the dashboard, merging the dashboard with a selected other dashboard, sharing the dashboard with other users or teams (or otherwise changing the visibility of the dashboard), or removing the dashboard.

Some embodiments of the chatbot system 202 can also allow the user to generate different versions of the dashboard being viewed, or selected items of content on the dashboard. FIG. 10f is a view of the dashboard depicted in FIG. 10e in which the user has selected the AI-generated graph 1024 and invoked an Options menu 1032 listing actions that can be performed on the selected item of content. From this menu 1032, the user has selected an option to generate versions of the selected content item. Selecting this option causes the dashboard to render a new window that displays optional versions of the selected content that can be added to the dashboard. FIG. 10g is a view of the dashboard in which a Versions window 1034 for the selected graph 1024 has been invoked. When the user requests other versions of a selected content item to be generated, the generative AI component 208 can generate suitable alternative versions of the selected item based on such factors as the type of the content item (e.g., a graph, a chart, a graphical meter displaying a current value of a key performance metric or metered value, etc.) and the type of information being conveyed by the content item. In the illustrated example, the original graph 1024 is a line graph. The system 202 has generated two alternative versions 1024b (a horizontal bar chart) and 1024c (a vertical bar chart) that convey similar information to that of the selected graph 1024 in respective different formats, and has rendered these versions 1024b and 1024c together with the original version 1024a on the Versions window 1034. If desired, the user can add any of the alternative versions to the main dashboard by selecting the corresponding Version checkboxes 1040. When adding an alternative version of the content item, the user can opt to replace the original version of the item or to add the alternative version as an additional content item without removing the original. From this Versions window 1034, the user can also refine any of the versions by submitting prompts via prompt entry field 1042.

FIG. 10h is another example prompt-based dashboard that can be rendered on the chatbot interface 310. In this example, the generative AI component 208 has processed the quick actions or prompts defined for the dashboard and generated various information modules 1044 based on these prompts. These modules 1044 can convey such information as alarm statistics for selected industrial assets, diagnostic log information for industrial assets, device statistics for selected industrial devices, descriptions of maintenance issues for selected industrial assets, scrap count statistics for selected production lines or machines, resource consumption and emissions statistics, predictive information such as yield productions, or other such information.

Once a prompt-based dashboard has been generated, the system 202 can display any live or historical data values collected from relevant industrial devices or assets, depending on the information that the dashboard has been designed to present. These data values can be collected by the system's device interface component 210 via the plant network on which the assets reside and any intervening public or private networks. If the dashboard has been designed to present selected sets of real-time data, the device interface component 210 can collect these data values from the relevant devices (e.g., from data tags or registers of industrial controllers or other types of industrial devices or systems) and the user interface component 204 can render these values in their respective alphanumeric or graphical formats in accordance with the dashboard definition.

Although the example dashboard workflows described above consider scenarios in which a user manually selects a dashboard to be executed and rendered, some embodiments of the system can also allow the user to configure dashboards that execute automatically on a period basis, or in response to defined trigger conditions.

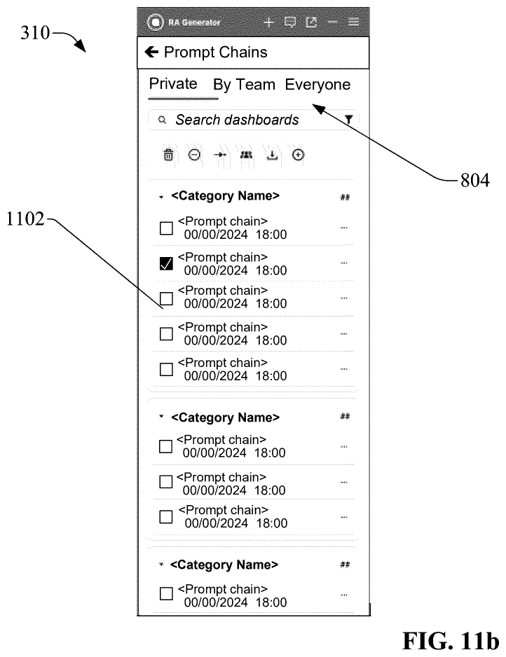

Some embodiments of the chatbot system 202 can also allow users to chain quick prompts (or quick actions) to build more complex responses from the system 202 as well as feed dashboards and trigger actions, such as notifications, based on conditional logic. FIG. 11a is an example prompt chain configuration interface 1106 that can be used to define prompt chains and conditions for executing these chains. The prompt chain configuration interface 1106 can include fields for configuring general properties of the prompt chain, including a Flow Name field 1108 and a Description field 1110 for defining a name and description of the prompt chain, an Icon field 1112 for specifying a graphical icon to be used to represent the prompt chain, and a Visibility field 1114 for setting the visibility of the chain (e.g., private, public, accessible to selected users or teams, etc.).

To build a prompt chain, the user can add graphical function blocks 1102 to the interface's workspace or canvas, and connect these blocks 1102 with flow lines 1116. The resulting function blocks 1102 and flow connections between the blocks 1102 define both the prompt chain itself as well as the conditions under which the chain will be executed. Various types of function blocks 1102 are provided by the system 202 and can be selectively added to the workspace, including function blocks 1102 that define prompt functions to be executed (e.g., blocks 1102c and 1102d), function blocks that define trigger conditions (e.g., block 1102a), and function blocks that define conditional checks that determine which of multiple alternative prompt functions will be executed (e.g., function block 1102b).

In the illustrated example, function block 1102a represents a time-based trigger function that defines a time at which the prompt chain will execute (daily at 3:00 pm). The output of this function block 1102a is connected, using a flow line 1116, to a conditional function block 1102b that defines a metric that will determine which of two defined quick prompts will be executed in response to the trigger. In this case, the metric to be checked is a count change value, which will be read when the daily trigger occurs. The output of this conditional function block 1102b is connected to two prompt function blocks 1102c and 1102d via respective value condition blocks 1104. The value condition blocks 1104 define mutually exclusive value ranges for the count change. The system 202 will execute the prompt function block 1102c or 1102d whose associated value condition block 1104 is satisfied by the count change value at the time of the trigger. In the illustrated example, if the count change is below 10, the quick prompt represented by prompt function block 1102c (Generate Report) is executed. Alternatively, if the count change is not below 10, the quick prompt represented by prompt function block 1102d is executed (Escalate and Analyze).

The user can add, remove, organize, and connect function blocks 1102 as desired to define, in a low-code manner, a chain of quick prompts as well as conditions under which those prompts will be submitted to the generative AI component 208 for processing. Selecting the Save button 1118 on the interface 1106 will save the defined configuration as a prompt chain. FIG. 11b is a Prompt Chain view of the chatbot interface 310 that lists defined prompt chains by name. As in the case of threads and quick actions (see, e.g., FIGS. 8f and 10a), users can use navigation bar 804 to selectively view private prompt chains, prompt chains that are associated with a specific team, or prompt chains accessible by all registered users. Prompt chains can also be assigned to defined categories, and the Prompt Chain view can organize the lists of prompt chains according to these categories.

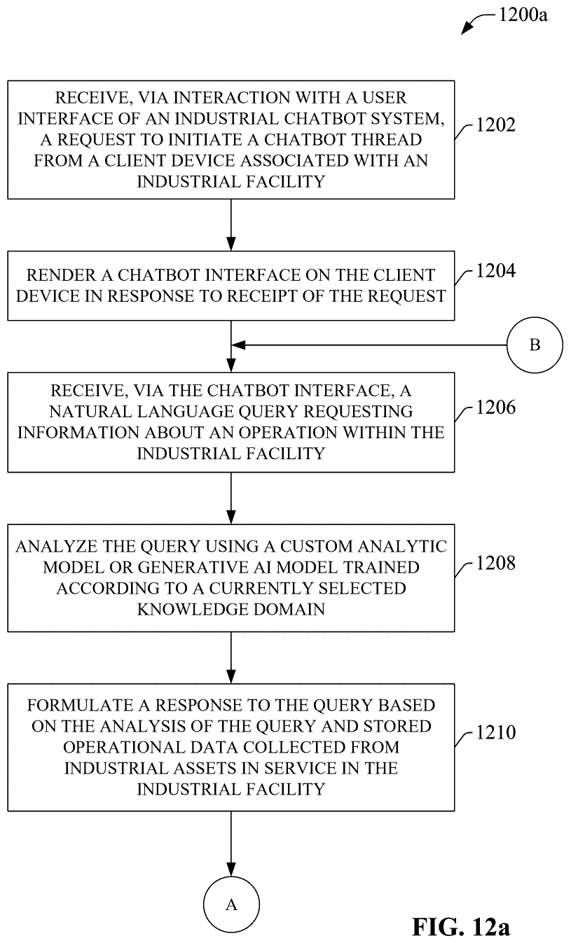

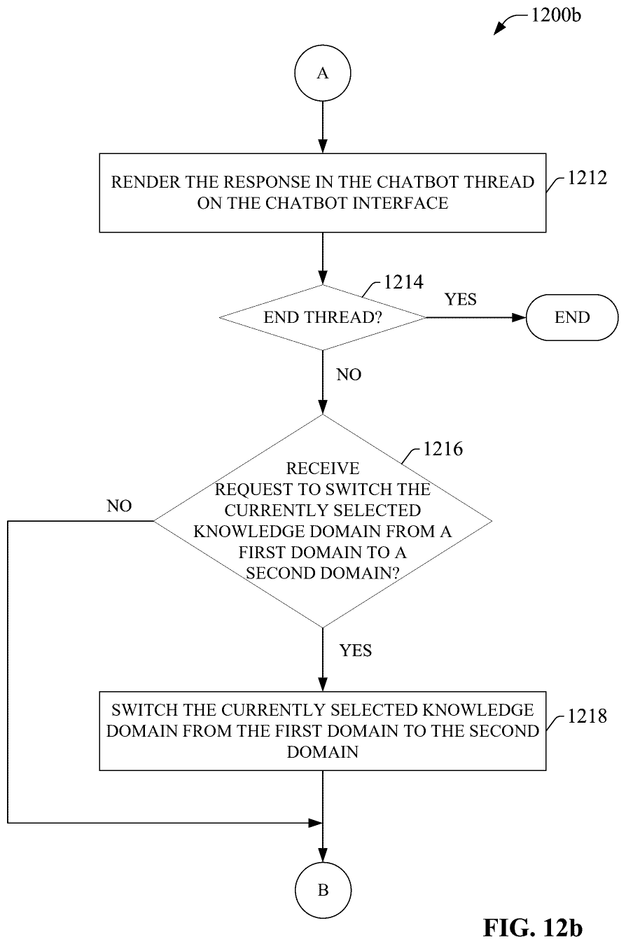

FIGS. 12a-15b illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 12a illustrates a first part of an example methodology 1200a for switching a knowledge domain within a chatbot thread managed by an industrial chatbot system. Initially, at 1202, a request to initiate a chatbot thread is received by an industrial chatbot system. The request is received from a client device associated with an industrial facility, via interaction with a user interface rendered on the client device by the chatbot system. At 1204, in response to receipt of the request at step 1202, a chatbot interface is rendered on the client device. The chatbot interface will serve as a container for messages generated and exchanged as part of the chatbot thread.

At 1206, a natural language query requesting information about an operation within the industrial facility is received via interaction with the chatbot interface. The query may be, for example, a request for a recommended technical support action for mitigating an issue described by the query, are request for information about a specified industrial asset or manufacturing operation, a request for a graph or chart conveying requested information about an industrial asset's production or status history in a specified format, or other such queries.

At 1208, the query received at step 1206 is analyzed using a custom analytic model or generative AI model trained according to a currently selected knowledge domain. In this regard, the industrial chatbot system can be configured to support multiple different knowledge domains or personas, where each knowledge domain leverages a different custom analytic model trained with a set of domain-specific training data, or a different generative AI model fine-tuned to align with a specific knowledge domain. Example knowledge domains can include, but are not limited to, an energy management domain, a plant efficiency domain, a plant security domain, a controls engineering domain, a financial domain, a domain specific to a particular industrial software platform, a work order domain, a data optimization domain, a batch process analytics domain, a domain specific to an industrial vertical (e.g., automotive, food and drug, textiles, mining, etc.), or other such domains. At 1210, a response to the query received at step 1206 is formulated based on the analysis performed at step 1208, as well as relevant subsets of stored operational data collected from industrial assets in service in the industrial facility.

The methodology then proceeds to the second part 1200b illustrated in FIG. 12b. At 1212, the response formulated at step 1210 is rendered in the chatbot thread on the chatbot interface. At 1214, a determination is made as to whether the current chatbot thread has been ended by the user. If so (YES at step 1214), the methodology ends. Alternatively, if the thread is not ended (NO at step 1214), the methodology proceeds to step 1216, were a determination is made as to whether a request is received, via interaction with the chatbot interface, to switch the knowledge domain that is currently selected for the chatbot thread from a first domain to a second domain. This request can be received, for example, via interaction with an icon-based or text-based window of the chatbot interface that renders the available knowledge domains as icons or as selectable text descriptions. If a request to switch the currently selected knowledge domain is received (YES at step 1216), the methodology proceeds to step 1218, where the currently selected knowledge domain is switched from the first domain to the second domain. The methodology then returns to step 1206, and steps 1206-1214 are repeated for another natural language query submitted by the user. In this subsequent iteration, the query is analyzed at step 1208 using a custom analytic model or generative AI model trained according the second knowledge domain selected at step 1216. Queries and responses during this next iteration are handled by the chatbot system as being part of the same chatbot thread as the previous iteration, and so are rendered on the chatbot interface as part of the ongoing chatbot thread. If a request to switch the currently selected domain is not received (NO at step 1216), the methodology returns to step 1206 without first executing step 1218 to switch the domain.

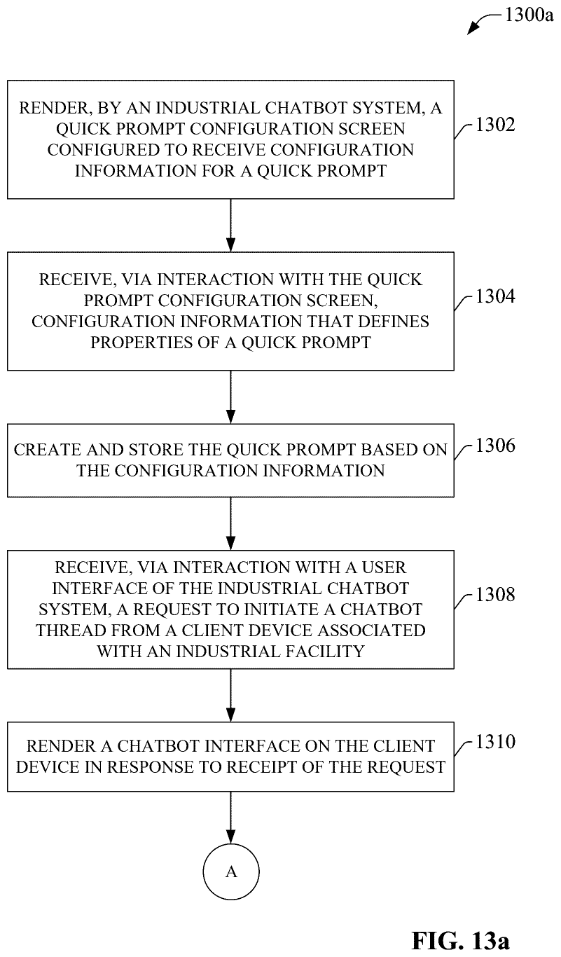

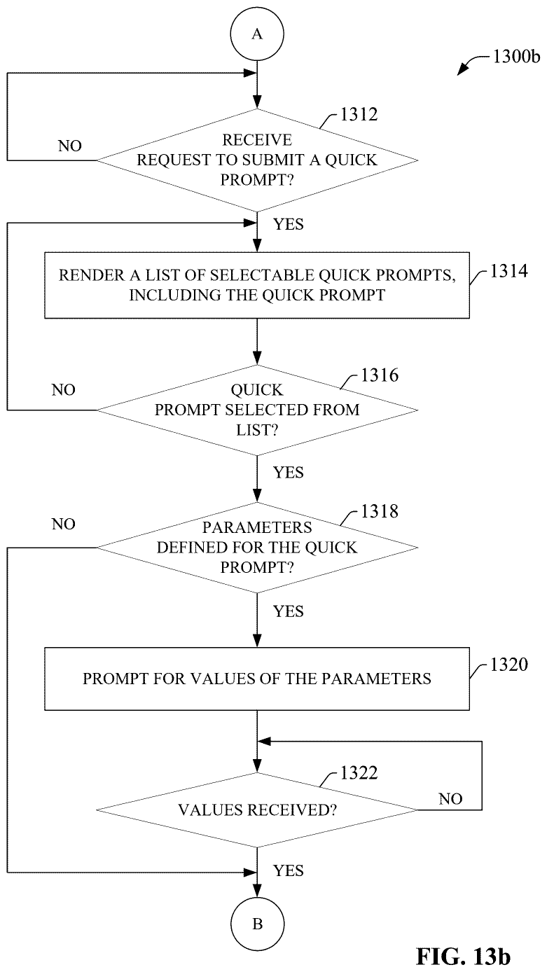

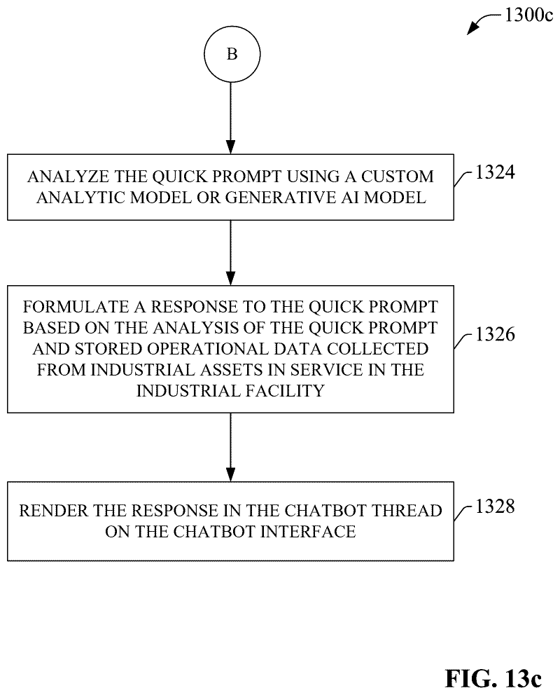

FIG. 13a illustrates a first part of an example methodology 1300a for configuring and submitting a quick prompt within an industrial chatbot system. Initially, at 1302, a quick prompt configuration screen is rendered by the industrial chatbot system. The quick prompt configuration screen is configured to receive information for a quick prompt to be stored for future use within the chatbot system. The quick prompt configuration screen can be invoked by selecting a suitable control of the chatbot system's interface to initiate creation of a quick prompt, or by selecting a prompt that has already been submitted as part of a chat thread and which the user wishes to use as the basis for a reusable quick prompt.

At 1304, configuration information that defines properties of a quick prompt are received via interaction with the quick prompt configuration screen rendered at step 1302. This configuration information can include, but is not limited to, text or syntax of the quick prompt, an optional alias for the quick prompts, a selection of an optional graphical icon to be used to represent the quick prompt, a visibility of the quick prompt (e.g., public, private, available to specific selected users, etc.), or other such configuration input. The user can also define portions of the quick prompt text that are to be made configurable parameters whose values are set by the user at the time the quick prompt is submitted. At 1306, the quick prompt is created and stored based on the configuration information received at step 1304.

At 1308, a request to initiate a chatbot thread from a client device associated with an industrial facility is received via interaction with the industrial chatbot system's user interface (similar to step 1202 of methodology 1200a). At 1310, a chatbot interface is rendered on the client device in response to receipt of the request (similar to step 1204 of methodology 1200a). The chatbot interface can be used to submit natural language prompts to the chatbot system and to receive responses to the prompts generated by the system. The methodology then proceeds to the second part 1300b illustrated in FIG. 13b

At 1312, a determination is made as to whether a request so submit a quick prompt is received via interaction with the chatbot interface. If a request to submit a quick prompt is received (YES at step 1312), the methodology proceeds to step 1314, where a list of selectable quick prompts is rendered. This list of selectable quick prompts includes quick prompts that were previously configured by the user, including the quick prompt created at step 1306. At 1316, a determination is made as to whether the quick prompt that was configured at step 1306 is selected via interaction with the list rendered at step 1314. If the quick prompt is selected from the list (YES at step 1316), the methodology proceeds to step 1318, where a determination is made as to whether configurable parameters had been defined for the selected quick prompt at the time the quick prompt was configured (as part of step 1304). If the quick prompt was defined to include one or more configurable parameters (YES at step 1318), the methodology proceeds to step 1320, where the chatbot system prompts the user for values of the parameters. At 1322, a determination is made as to whether the values of the configurable parameters are received. When the values have been received via interaction with the chatbot interface, the methodology proceeds to the third part 1300c illustrated in FIG. 13c. If no parameters have been defined for the selected quick prompt (NO at step 1318), the methodology proceeds to the third part 1300c without performing steps 1320 and 1322.

At 1324, the selected quick prompt is analyzed using a custom analytic model or generative AI model (similar to step 1208 of methodology 1200a). At step 1326, a response to the quick prompt is formulated based on the analysis performed at step 1324 (similar to step 1210 of methodology 1200a). At 1328, the response is rendered in the chatbot thread on the chatbot interface.

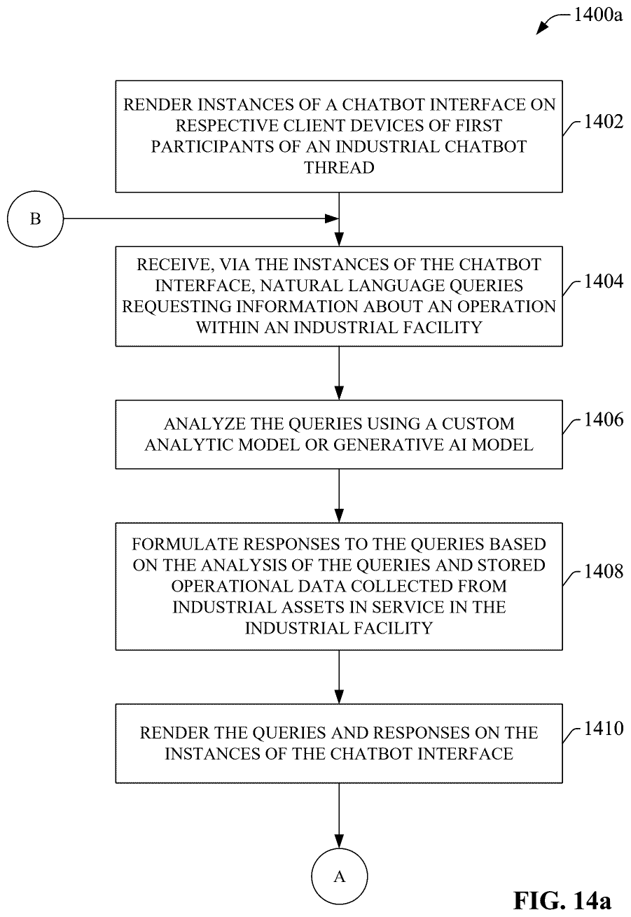

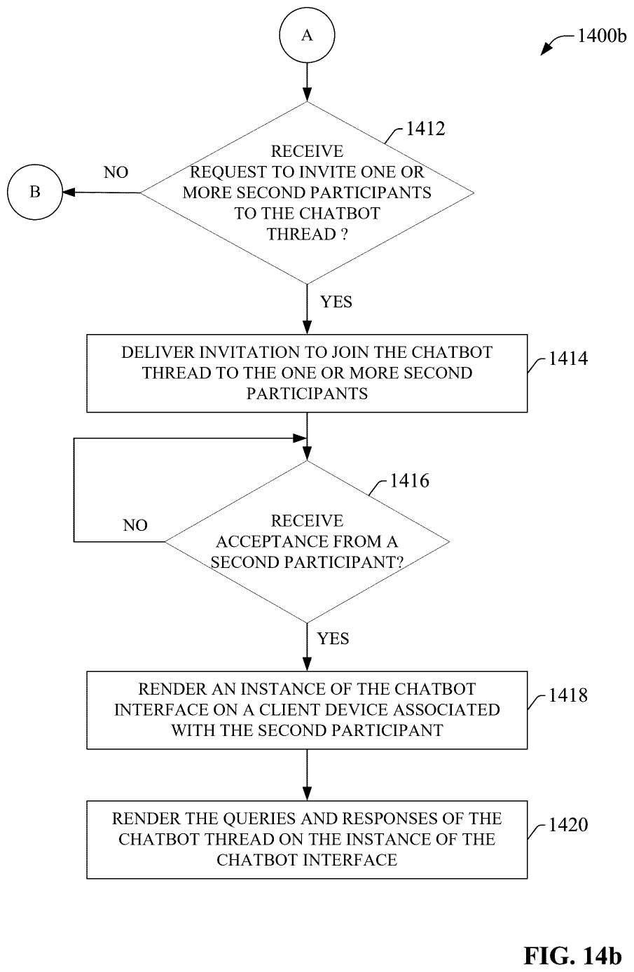

FIG. 14a illustrates a first part of an example methodology 1400a for inviting additional participants to an industrial chatbot thread. Initially, at 1402, instances of a chatbot interface are rendered on respective client devices of first participants of an industrial chatbot thread. At 1404, natural language queries requesting information about an operation within an industrial facility are received via the instances as part of a group participation in the chatbot thread. At 1406, during the chatbot thread, the queries are analyzed using a custom analytic model or a generative AI model. At 1408, responses to the queries are formulated based on the analysis of the queries performed at step 1406, as well as stored operational data collected from industrial assets in service in the industrial facility. At 1410, the queries and their corresponding responses are rendered on the instances of the chatbot interface.

The methodology then proceeds to the second part 1400b illustrated in FIG. 14b. At 1412, a determination is made as to whether a request to invite one or more second participants to the chatbot thread is received. This request can be received, for example, via interaction with one of the instances of the chatbot interface. In an example technique, one of the first participants can invoke an invitation window via the chatbot interface that lists the identities of users who are eligible to participate in the chatbot thread, and select a subset of these users to be invited to the current chatbot thread. If no such request is received (NO at step 1412), the methodology returns to step 1404 and the chatbot thread continues among the first participants. If a request to invite one or more second participants is received (YES at step 1412), the methodology proceeds to step 1414, where an invitation to join the chatbot thread is delivered to the one or more second participants selected at step 1412.

At 1416, a determination is made as to whether an acceptance of the invitation is received from a second participant of the one or more second participants. If the acceptance is received (YES at step 1416), the methodology proceeds to step 1418, where an instance of the chatbot interface is rendered on a client device associated with the second participant. At 1420, the queries and response of the chatbot thread that have already been submitted and rendered as part of the chatbot thread are rendered on the instance of the chatbot interface rendered at step 1418.

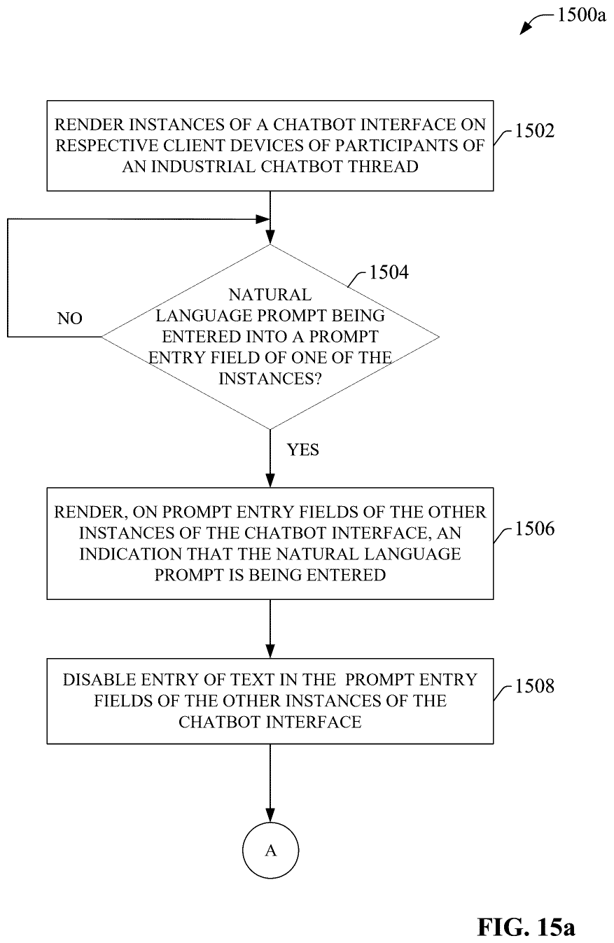

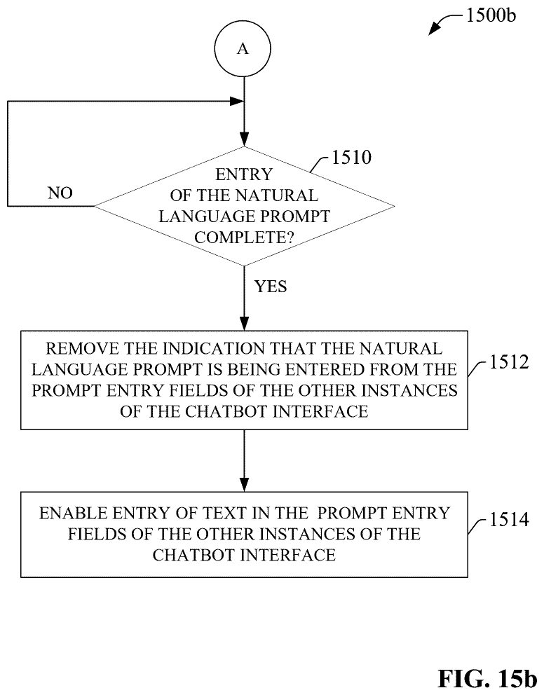

FIG. 15a illustrates a first part of an example methodology 1500a for regulating entry of natural language prompts in a multi-user industrial chatbot thread. Initially, at 1502, instances of a chatbot interface are rendered on respective client devices of participants of an industrial chatbot thread. At 1504, a determination is made as to whether a natural language prompt is being entered into a prompt entry field of one of the instances of the chatbot interface. If a natural language prompt is being entered (YES at step 1504), the methodology proceeds to step 1506, where an indication that the natural language prompt is being entered is rendered on prompt entry fields of the other instances of the chatbot interface. Additionally, at 1508, entry of text in the prompt entry fields of the other instances of the chatbot interfaces is disabled while the natural language prompt is being entered.

The methodology then proceeds to the second part 1500b illustrated in FIG. 15b. At 1510, a determination is made as to whether entry of the natural language prompt into the prompt entry field has completed, either because the prompt has been submitted by the participant associated with the instance of the chatbot interface or the participant has canceled entry of the prompt. If entry of the prompt is not complete (NO at step 1510), the methodology waits while continuing to render the indication that the prompt is being entered (step 1506) and preventing entry of text in the prompt entry fields of the other instances of the chatbot interface (step 1508). When entry of the natural language prompt is complete (YES at step 1510), the methodology proceeds to step 1512, where the indication that the prompt is being entered is removed from the prompt entry fields of the other instances of the chatbot interfaces. Additionally, at 1514, entry of text in the prompt entry fields of the other instances of the chatbot interfaces is enabled.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC (programmable logic controller) or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

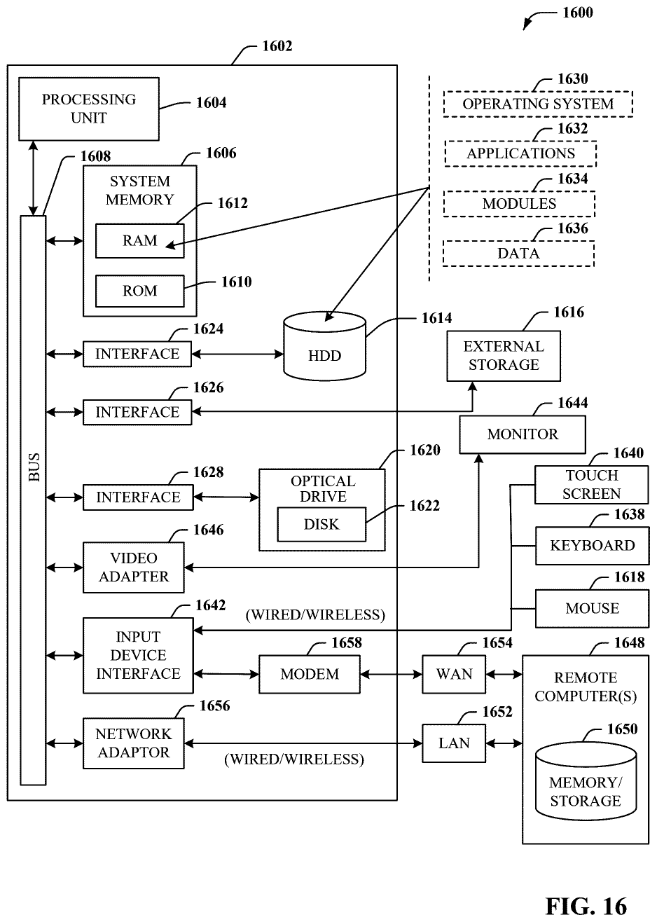

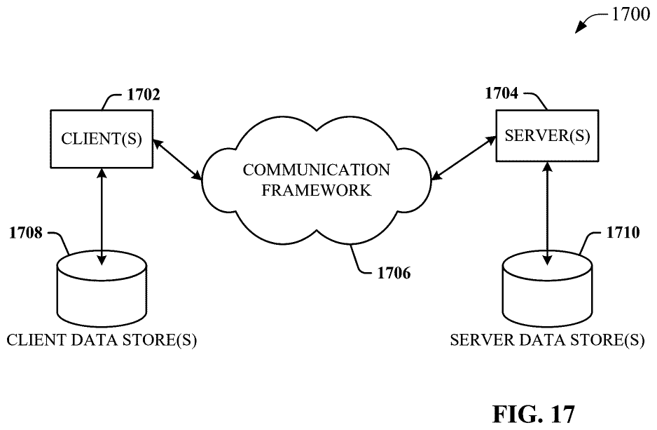

In order to provide a context for the various aspects of the disclosed subject matter, FIGS. 16 and 17 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16 the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the. NET framework, for application programs 1632. Runtime environments are consistent execution environments that allow application programs 1632 to run on any operating system that includes the runtime environment. Similarly, operating system 1630 can support containers, and application programs 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1618. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1644 or other type of display device can be also connected to the system bus 1608 via an interface, such as a video adapter 1646. In addition to the monitor 1644, a computer typically includes other peripheral output devices (not shown), such as speakers, printers, etc.

The computer 1602 can operate in a networked environment using logical connections via wired and/or wireless communications to one or more remote computers, such as a remote computer(s) 1648. The remote computer(s) 1648 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1652 through a wired and/or wireless communication network interface or adapter 1656. The adapter 1656 can facilitate wired or wireless communication to the LAN 1652, which can also include a wireless access point (AP) disposed thereon for communicating with the adapter 1656 in a wireless mode.

When used in a WAN networking environment, the computer 1602 can include a modem 1658 or can be connected to a communications server on the WAN 1654 via other means for establishing communications over the WAN 1654, such as by way of the Internet. The modem 1658, which can be internal or external and a wired or wireless device, can be connected to the system bus 1608 via the input device interface 1642. In a networked environment, program modules depicted relative to the computer 1602 or portions thereof, can be stored in the remote memory/storage device 1650. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1652 or WAN 1654 e.g., by the adapter 1656 or modem 1658, respectively. Upon connecting the computer 1602 to an associated cloud storage system, the external storage interface 1626 can, with the aid of the adapter 1656 and/or modem 1658, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 17 is a schematic block diagram of a sample computing environment 1700 with which the disclosed subject matter can interact. The sample computing environment 1700 includes one or more client(s) 1702. The client(s) 1702 can be hardware and/or software (e.g., threads, processes, computing devices). The sample computing environment 1700 also includes one or more server(s) 1704. The server(s) 1704 can also be hardware and/or software (e.g., threads, processes, computing devices). The servers 1704 can house threads to perform transformations by employing one or more embodiments as described herein, for example. One possible communication between a client 1702 and servers 1704 can be in the form of a data packet adapted to be transmitted between two or more computer processes. The sample computing environment 1700 includes a communication framework 1706 that can be employed to facilitate communications between the client(s) 1702 and the server(s) 1704. The client(s) 1702 are operably connected to one or more client data store(s) 1708 that can be employed to store information local to the client(s) 1702. Similarly, the server(s) 1704 are operably connected to one or more server data store(s) 1710 that can be employed to store information local to the servers 1704.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a generative artificial intelligence (AI) component configured to initiate a chatbot thread, to process natural language prompts received as part of the chatbot thread requesting information about industrial operations within an industrial facility, and to generate, based on generative AI analysis of the natural language prompts, responses to the natural language prompts, the responses comprising at least one of natural language information or graphical content, wherein the generative AI analysis is performed using an analytic model, of a set of available analytic models, trained with a set of training data relevant to a knowledge domain that is currently selected for the chatbot thread; and
a user interface component configured to render a chatbot interface that receives the natural language prompts and renders the natural language prompts and responses of the chatbot thread,
wherein the generative AI component is further configured to switch the knowledge domain that is currently selected for the chatbot thread from a first knowledge domain to a second knowledge domain in response to receipt, via interaction with the chatbot interface, of a request to switch the chatbot thread to the second knowledge domain.

2. The system of claim 1, wherein
the user interface is configured to render, on the chatbot interface, a domain switching window that renders icons representing respective knowledge domains available for processing the natural language prompts, and
the request to switch the chatbot thread to the second knowledge domain is received via selection of one of the icons representing the second knowledge domain.

3. The system of claim 1, wherein
the user interface is configured to render, on the chatbot interface, a domain switching window that renders a list of selectable domain names representing respective knowledge domains available for processing the natural language prompts, and
the request to switch the chatbot thread to the second knowledge domain is received via selection of one of the selectable domain names representing the second knowledge domain.

4. The system of claim 1, wherein at least one of the first knowledge domain or the second knowledge domain is at least one of an energy management domain, a plant efficiency domain, a plant security domain, a controls engineering domain, a financial domain, a domain specific to an industrial software platform, a work order domain, a data optimization domain, a batch process analytics domain, or a domain specific to an industrial vertical.

5. The system of claim 1, wherein
the generative AI component is further configured to generate the responses further based on a currently selected user role,
the user interface component is further configured to, in response to receipt, via interaction with the chatbot interface, of a request to change the currently selected user role, render a role selection window that displays a list of selectable user roles, and
the generative AI component is further configured to, in response to selection of a user role from the list of selectable user roles, set the currently selected user role to the user role selected from the list.

6. The system of claim 5, wherein the currently selected user role is one of a controls engineer role, a plant manager role, a line operator role, or a maintenance role.

7. The system of claim 1, wherein
the user interface component is further configured to render, on the chatbot interface, a persona settings window comprising controls for configuring properties of a knowledge domain used by the generative AI component, and
the generative AI component is further configured to set one or more settings of the knowledge domain based on configuration input received via interaction with the controls,
the controls comprising at least one of a control that selects a knowledge domain to be configured, a control that sets the currently selected user role to be used for the knowledge domain, a control that sets a creativity level of the knowledge domain, or a control that sets an initial prompt to be rendered in the chatbot thread upon initiation of a chat thread using the knowledge domain.

8. The system of claim 5, wherein
the user interface component is configured to
render, on the chatbot interface, a sequential list of the natural language prompts that were submitted for the chatbot thread and the responses to the natural language prompts that were generated for the chatbot thread based on a first user role, and
in response to receipt, via interaction with the chatbot interface, of a request to reanalyze a selected natural language prompt from the list based on a selected second user role, initiate resubmission of the natural language prompt for processing based on the second user role,
the generative AI component is further configured to generate a replacement response to the selected natural language prompt based on generative AI analysis of the selected natural language prompt and the second user role, and
the user interface component is further configured to replace a response to the selected natural language prompt that was previously displayed on the list with the replacement response.

9. The system of claim 1, wherein
the user interface component is configured to
render, on the chatbot interface, a sequential list of the natural language prompts that were submitted for the chatbot thread and the responses to the natural language prompts that were generated by the generative AI component based on the first knowledge domain, and
in response to receipt, via interaction with the chatbot interface, of a request to reanalyze a selected natural language prompt from the list that was previously processed based on the first knowledge domain, initiate resubmission of the natural language prompt for re-processing based on the second knowledge domain,
the generative AI component is further configured to generate a replacement response to the selected natural language prompt based on generative AI analysis of the selected natural language prompt in accordance with the second knowledge domain, and
the user interface component is further configured to replace a response to the selected natural language prompt that was previously displayed on the list with the replacement response.

10. The system of claim 1, wherein respective analytic models of the set of analytic models are trained with respective different sets of training data relevant to respective different knowledge domains.

11. A method, comprising:
in response to initiation of a chatbot thread, rendering, by an industrial chatbot system comprising a processor, a chatbot interface;
receiving, by an industrial chatbot system via interaction with the chatbot interface, selection of a first knowledge domain, from a set of available knowledge domains to be used for the chatbot thread;
in response to receiving, via interaction with the chatbot interface as part of the chatbot thread, natural language prompts requesting information about industrial operations within an industrial facility, generating, by the industrial chatbot system based on generative artificial intelligence (AI) analysis of the natural language prompts, responses to the natural language prompts, wherein
the responses comprising at least one of natural language information or graphical content, and
the generating comprises performing the generative AI analysis using a first analytic model, of a set of available analytic models respectively corresponding to the set of available knowledge domains, trained with a first set of training data relevant to the first knowledge domain; and
in response to receiving, via interaction with the chatbot interface, a request to switch the chatbot thread from the first knowledge domain to a second knowledge domain of the set of available knowledge domains, switching, by the industrial chatbot system, the chatbot thread to the second knowledge domain,
wherein the switching comprises using a second analytic model, of the set of available analytic models, trained with a second set of training data relevant to the first knowledge domain to analyze subsequent natural language prompts received in the chatbot thread.

12. The method of claim 11, wherein the receiving of the request to switch the chatbot thread from the first knowledge domain to a second knowledge domain comprises:
rendering, on the chatbot interface, a domain switching window that renders icons representing the set of available knowledge domains, and
receiving, as the request, a selection of one of the icons representing the second knowledge domain via interaction with the domain switching window.

13. The method of claim 11, wherein the receiving of the request to switch the chatbot thread from the first knowledge domain to a second knowledge domain comprises:
rendering, on the chatbot interface, a domain switching window that renders a list of selectable domain names representing the set of available knowledge domains, and
receiving, as the request, a selection of one of the selectable domain names representing the second knowledge domain via interaction with the domain switching window.

14. The method of claim 11, wherein the set of available knowledge domains comprise at least one of an energy management domain, a plant efficiency domain, a plant security domain, a controls engineering domain, a financial domain, a domain specific to an industrial software platform, a work order domain, a data optimization domain, a batch process analytics domain, or a domain specific to an industrial vertical.

15. The method of claim 11, wherein
the generating of the responses comprises generating the responses further based on a currently selected user role, and
the method further comprises:
in response to receiving, via interaction with the chatbot interface, a request to change the currently selected user role, rendering a role selection window that displays a list of selectable user roles, and
in response to receiving, via interaction with the role selection window, selection of a user role from the list of selectable user roles, setting, by the industrial chatbot system, the currently selected user role to the user role selected from the list.

16. The method of claim 15, wherein the currently selected user role is one of a controls engineer role, a plant manager role, a line operator role, or a maintenance role.

17. The method of claim 11, further comprising:
rendering, by the industrial chatbot system on the chatbot interface, a persona settings window comprising controls for configuring properties of a knowledge domain of the set of available knowledge domains; and
setting, by the industrial chatbot system, one or more settings of the knowledge domain based on configuration input received via interaction with the controls,
wherein the controls comprise at least one of a control that selects a knowledge domain to be configured, a control that sets a user role to be used for the knowledge domain, a control that sets a creativity level of the knowledge domain, or a control that sets an initial prompt to be rendered in the chatbot thread upon initiation of a chat thread using the knowledge domain.

18. The method of claim 15, further comprising:
rendering, by the industrial chatbot system on the chatbot interface, a sequential list of the natural language prompts that were submitted in the chatbot thread and the responses to the natural language prompts that were generated in the chatbot thread based on a first user role;
in response to receiving, via interaction with the chatbot interface, a request to reanalyze a selected natural language prompt from the list based on a selected second user role, resubmitting, by the industrial chatbot system, the natural language prompt for processing based on the second user role;
generating, by the industrial chatbot system, a replacement response to the selected natural language prompt based on generative AI analysis of the selected natural language prompt and the second user role; and
replacing, by the industrial chatbot system, a response to the selected natural language prompt that was previously displayed on the list with the replacement response.

19. A non-transitory computer-readable medium having stored thereon instructions that, in response to execution, cause an industrial chatbot system comprising a processor to perform operations, the operations comprising:
rendering a chatbot interface in response to initiation of a chatbot thread;
receiving, via interaction with the chatbot interface, selection of a first knowledge domain, from a set of available knowledge domains to be used for the chatbot thread;
in response to receiving, via interaction with the chatbot interface as part of the chatbot thread, natural language prompts requesting information about industrial operations within an industrial facility, generating, based on generative artificial intelligence (AI) analysis of the natural language prompts, responses to the natural language prompts, wherein
the responses comprising at least one of natural language information or graphical content, and
the generating comprises performing the generative AI analysis using a first analytic model, of a set of available analytic models respectively corresponding to the set of available knowledge domains, trained with a first set of training data relevant to the first knowledge domain; and
in response to receiving, via interaction with the chatbot interface, a request to switch the chatbot thread from the first knowledge domain to a second knowledge domain of the set of available knowledge domains, switching the chatbot thread to the second knowledge domain,
wherein the switching comprises using a second analytic model, of the set of available analytic models, trained with a second set of training data relevant to the first knowledge domain to analyze subsequent natural language prompts received in the chatbot thread.

20. The non-transitory computer-readable medium of claim 19, wherein the receiving of the request to switch the chatbot thread from the first knowledge domain to a second knowledge domain comprises:
rendering, on the chatbot interface, a domain switching window that renders icons representing the set of available knowledge domains, and
receiving, as the request, a selection of one of the icons representing the second knowledge domain via interaction with the domain switching window.
